(19) United States
(12) Patent Application Publication
(10) Pub. No.: US 2008/0215789 A1
(43) Pub. Date: Sep. 4, 2008

(54) Data transfer control device and electronic instrument

(75) Inventors: Kuniaki Matsuda, Sapporo-shi (JP); Chisato Akiyama, Sapporo-shi (JP); Nobuyuki Saito, Sapporo-shi (JP); Haruo Nishida, Sapporo-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/068,180

(22) Filed: Feb. 4, 2008

(30) Foreign Application Priority Data
Feb. 19, 2007 (JP) 2007-037828

(51) Int. Cl. G06F 13/28

(52) U.S. Cl. 710/308

(57) ABSTRACT

A data transfer control device includes a PATA I/F connected to a PATA bus, a SATA I/F connected to a SATA bus, and a sequence controller that controls a transfer sequence. The PATA I/F includes a task file register that is a pseudo register provided to implement a PATA/SATA bus bridge, and the SATA I/F includes a shadow task file register, a register value being transferred between the shadow task file register and the task file register.

Japanese Patent Application No. 2007-37828 filed on Feb. 19, 2007, is hereby incorporated by reference in its entirety.

### BACKGROUND OF THE INVENTION

The present invention relates to a data transfer control device, an electronic instrument, and the like.

In recent years, the Serial AT Attachment (Serial ATA) standard has attracted attention aimed at a serial interface for storage devices and the like. The Serial ATA standard has software-level compatibility with the Parallel ATA (IDE) standard. The data transfer rate of the original Serial ATA I standard is 1.5 Gbps. In the next Serial ATA II Gen2 standard, the data transfer rate is increased 3.0 Gbps. The number of interconnects provided between circuit boards included in an electronic instrument can be reduced utilizing the Serial ATA standard, whereby the size of the electronic instrument can be reduced.

On the other hand, a host (host device or host board) of an electronic instrument includes a parallel ATA (hereinafter appropriately referred to as “PATA”) interface (hereinafter appropriately referred to as “I/F”), but generally does not include a Serial ATA (hereinafter appropriately referred to as “SATA”) I/F. Therefore, a SATA device cannot be connected to a host which includes only a PATA I/F.

Devices such as a hard disk drive (HDD) have been increasingly equipped with a SATA I/F instead of a PATA I/F. Therefore, it is difficult to obtain an HDD equipped with a PATA I/F. As a result, the type of HDD which can be connected to a host which includes only a PATA I/F is limited, whereby an increase in capacity of a built-in HDD of electronic instruments is hindered.

JP-A-2005-346123 and JP-A-2006-121621 disclose a SATA/PATA bridge IC. JP-A-2005-346123 and JP-A-2006-121621 disclose inventions relating to a circuit board using the bridge IC and the like, but do not disclose an invention relating to a specific configuration of the bridge IC.

JP-A-2006-18428 discloses an HDD including a SATA bridge. The SATA bridge disclosed in JP-A-2006-18428 is a bridge in which a host is connected to the SATA side and a device is connected to the PATA side. Specifically, JP-A-2006-18428 does not disclose an invention relating to a bridge in which a host is connected to the PATA side and a device is connected to the SATA side. JP-A-2006-18428 discloses an invention characterized by protocol control using firmware, but does not disclose a characteristic circuit configuration.

### SUMMARY

According to one aspect of the invention, there is provided a data transfer control device that has a Parallel ATA/Serial ATA bus bridge function, the data transfer control device comprising:

a Parallel ATA interface that is connected to a Parallel ATA bus and provides an interface with a host;

a Serial ATA interface that is connected to a Serial ATA bus and provides an interface with a Serial ATA device; and

a sequence controller that controls a transfer sequence,
the Parallel ATA interface including a task file register that is a pseudo register provided to implement a Parallel ATA/Serial ATA bus bridge; and

the Serial ATA interface including a shadow task file register, a register value being transferred between the task file register and the shadow task file register.

According to another aspect of the invention, there is provided an electronic instrument comprising:

the above data transfer control device;

a host that is connected to the data transfer control device; and

a Serial ATA device that is connected to the data transfer control device.

### BRIEF DESCRIPTION OF THE SEVERAL VIEWS OF THE DRAWING

FIG. 1 is a configuration example of a data transfer control device according to one embodiment of the invention.

FIGS. 2A and 2B show PATA and SATA system configuration examples.

FIGS. 3A to 3C are views illustrative of a register value transfer method according to one embodiment of the invention.

FIGS. 4A to 4C are further views illustrative of a register value transfer method according to one embodiment of the invention.

FIG. 5 shows a detailed configuration example of a data transfer control device according to one embodiment of the invention.

FIGS. 6A and 6B show signal waveform examples during PIO read and PIO write.

FIGS. 7A and 7B show signal waveform examples during DMA read and DMA write.

FIG. 8 is a view illustrative of SATA transmitter-side data processing.

FIG. 9 is a view illustrative of SATA receiver-side data processing.

FIG. 10 shows a configuration example of a SATA I/F.

FIGS. 11A to 11D show FIS format examples.

FIG. 12 shows a configuration example of a sequence controller.

FIG. 13 shows a format example of a task file register.

FIG. 14 is a PIO read transfer sequence diagram.

FIG. 15 is a PIO write transfer sequence diagram.

FIG. 16 is a DMA read transfer sequence diagram.

FIG. 17 is a DMA write transfer sequence diagram.

FIG. 18 is a view illustrative of each status bit.

FIG. 19 is a flowchart illustrative of a PIO read operation.

FIG. 20 is a flowchart illustrative of a PIO write operation.

FIG. 21 is a flowchart illustrative of a DMA read operation.

FIG. 22 is a flowchart illustrative of a DMA write operation.

FIGS. 23A to 23C are views illustrative of a sequence control method according to one embodiment of the invention.

FIGS. 24A to 24C are further views illustrative of a sequence control method according to one embodiment of the invention.

FIG. 25 is a view illustrative of a register value transfer method using a trigger signal.

FIG. 26 is a view illustrative of an FIS interrupt signal.

FIGS. 27A and 27B are views illustrative of an SRST process.

FIG. 28 shows a configuration example of an electronic instrument.

### DETAILED DESCRIPTION OF THE EMBODIMENT

Aspects of the invention may provide a data transfer control device which enables a host including a Parallel ATA interface to be connected to a Serial ATA device, and an electronic instrument including the data transfer control device.

According to one embodiment of the invention, there is provided a data transfer control device that has a Parallel ATA/Serial ATA bus bridge function, the data transfer control device comprising:

a Parallel ATA interface that is connected to a Parallel ATA bus and provides an interface with a host;

a Serial ATA interface that is connected to a Serial ATA bus and provides an interface with a Serial ATA device; and

a sequence controller that controls a transfer sequence,

the Parallel ATA interface including a task file register that is a pseudo register provided to implement a Parallel ATA/Serial ATA bus bridge; and

the Serial ATA interface including a shadow task file register, a register value being transferred between the task file register and the shadow task file register.

According to this embodiment, the Parallel ATA interface includes the pseudo (virtual) task file register for a Parallel ATA/Serial ATA bus bridge, and the Serial ATA interface includes the shadow task file register, the register value being transferred between the shadow task file register and the pseudo task file register. The host can read and write data as if the Serial ATA device were a Parallel ATA device by providing the task file register. Therefore, a host which includes a Parallel ATA interface can be connected to a Serial ATA device through the data transfer control device, for example.

In the data transfer control device according to this embodiment, the data transfer control device may further comprise:

a data buffer that buffers data transferred between the host and the Serial ATA device,

data may be transferred between the host and the Serial ATA device through the data buffer; and

the register value may be transferred between the task file register and the shadow task file register through the sequence controller.

According to this configuration, the sequence controller can control a register value transfer sequence or a data transfer sequence through the data buffer while monitoring the register value transferred between the task file register and the shadow task file register, for example.

In the data transfer control device according to this embodiment, the sequence controller may output a transfer start signal, a transfer stop signal, and a transfer direction setting signal to the Parallel ATA interface and the Serial ATA interface to control a transfer sequence of data transferred between the host and the Serial ATA device through the data buffer.

According to this configuration, the Parallel ATA interface and the Serial ATA interface can determine the transfer start timing, the transfer stop timing, and the transfer direction, whereby an appropriate data transfer can be implemented.

In the data transfer control device according to this embodiment, when the host reads data from the Serial ATA device, the sequence controller may set the register value in the task file register after data transfer from the Parallel ATA interface to the host has been completed.

According to this configuration, the register value of the task file register can be set (updated) and the host can be notified of the register value after the sequence controller has confirmed that data transfer from the Parallel ATA interface to the host has been completed and data does not remain in the data transfer control device. This enables the host to perform an appropriate data read operation and the like.

In the data transfer control device according to this embodiment, when the host writes data into the Serial ATA device, the sequence controller may set the register value in the task file register after the sequence controller has received an FIS from the Serial ATA device, the FIS indicating completion of data transfer through the Serial ATA bus.

According to this configuration, the register value of the task file register can be set (updated) and the host can be notified of the register value after the sequence controller has confirmed that data transmission to the device has been completed utilizing the FIS received from the device. This enables the host to perform an appropriate data write operation and the like.

In the data transfer control device according to this embodiment, the sequence controller may transfer the register value from the task file register to the shadow task file register on condition that a parameter has been written into the task file register and then an ATA command has been written into the task file register.

This enables the register value to be transferred when the ATA command has been written, whereby the transfer process can be simplified.

In the data transfer control device according to this embodiment,

the Parallel ATA interface may activate a command write detection signal when the ATA command has been written into the task file register; and

the sequence controller may transfer the register value from the task file register to the shadow task file register when the command write detection signal has been activated.

Register value transfer control can be implemented using a small number of signal lines by utilizing the command write detection signal.

In the data transfer control device according to this embodiment,

each bit of a register group of the task file register and corresponding bit of a register group of the shadow task file register may be connected through the sequence controller; and

the sequence controller may generate a transfer trigger signal of the register value, and may transfer the register value between the task file register and the shadow task file register based on the generated transfer trigger signal.

This enables the register value to be transferred by simple control utilizing the transfer trigger signal.

In the data transfer control device according to this embodiment,

the Serial ATA interface may decode an FIS received from the Serial ATA device, and may generate and may output an interrupt signal that notifies the sequence controller of the type of the FIS based on the decoding result; and

the sequence controller may determine the type of the FIS based on the interrupt signal from the Serial ATA interface, and may control a transfer sequence of data and the register value.

According to this configuration, since the type of FIS can be determined by effectively utilizing the FIS decoder circuit originally necessary for the Serial ATA interface, the circuit scale can be reduced.

In the data transfer control device according to this embodiment,

when a soft reset bit of the task file register has been set at 1, the sequence controller may transfer the register value from the task file register to the shadow task file register, the soft reset bit of the register value being set at 1;

the Serial ATA interface may transmit a register FIS to the Serial ATA device, the soft reset bit of the register FIS being set at 1;

when the soft reset bit has been cleared to 0, the sequence controller may transfer the register value from the task file register to the shadow task file register, the soft reset bit of the register value being cleared to 0, and may start a soft reset initialization sequence process of the data transfer control device; and

the Serial ATA interface may cause the Serial ATA device to perform a soft reset initialization sequence process by transmitting a register FIS to the Serial ATA device, the soft reset bit of the register FIS being cleared to 0.

According to this configuration, the soft reset process can be appropriately implemented using the pseudo task file register.

In the data transfer control device according to this embodiment,

the Parallel ATA interface may output a soft reset detection signal to the sequence controller; and

the sequence controller may transfer the register value based on the soft reset detection signal output from the Parallel ATA interface.

According to this configuration, when the host has issued a soft reset request, the data transfer control device can immediately accept the request and notify the device of the request.

According to another embodiment of the invention, there is provided an electronic instrument comprising:

one of the above data transfer control devices;

a host that is connected to the data transfer control device; and

a Serial ATA device that is connected to the data transfer control device.

Preferred embodiments of the invention are described below in detail. Note that the embodiments described below do not in any way limit the scope of the invention defined by the claims laid out herein. Note that all elements of the embodiments described below should not necessarily be taken as essential requirements for the invention.

1. Configuration of Data Transfer Control Device

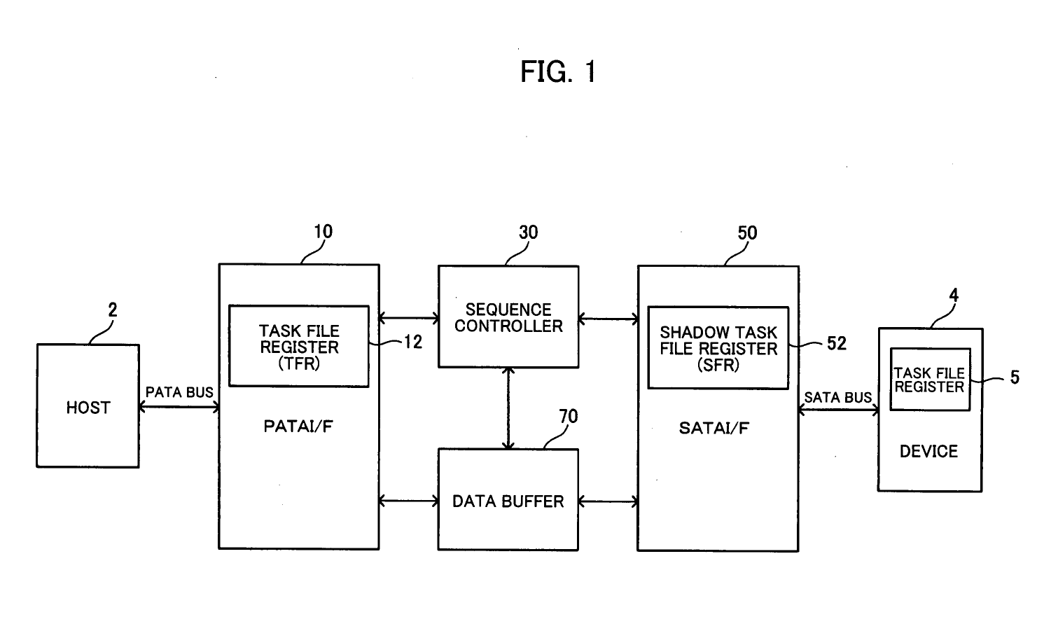

FIG. 1 shows a configuration example of a data transfer control device according to one embodiment of the invention. The data transfer control device has a bus bridge function between Parallel AT Attachment (PATA) and Serial AT Attachment (SATA). Note that the data transfer control device according to this embodiment is not limited to the configuration shown in FIG. 1. Various modifications may be made such as omitting some elements (e.g., data buffer) or adding other elements (e.g., external I/F circuit, CPU, or timer).

A PATA I/F 10 (parallel ATA interface) is connected to a PATA bus (ATA bus or IDE bus), and provides an interface with a host 2 (host device). Specifically, the PATA I/F 10 is connected to a host-side PATA I/F included in the host 2 through the PATA bus. The PATA I/F 10 exchanges various ATA signals described later with the host-side PATA I/F to implement PATA (IDE) data transfer. The PATA I/F 10 also controls data transfer with a SATA I/F 50 through a data buffer 70.

The host 2 may be a processor such as a CPU, an MPU, or a DSP, a dedicated control IC, a host circuit board on which such a processor or dedicated control ICs is mounted, or the like. A device 4 may be a device including a SATA I/F, such as a hard disk drive (HDD), an optical disk (CD or DVD) drive, or a magnetic disk drive.

The SATA I/F 50 (Serial ATA interface) is connected to a SATA bus (high-speed serial bus), and provides an interface with the SATA device 4. Specifically, the SATA I/F 50 is connected to a device-side SATA I/F included in the device 4, and exchanges data using small-amplitude differential signals to implement SATA data transfer. The SATA I/F 50 also controls data transfer with the PATA I/F 10 through the data buffer 70.

A sequence controller 30 controls a transfer sequence. Specifically, the sequence controller 30 controls a data transfer sequence among the PATA I/F 10, the SATA I/F 50, and the data buffer 70 or controls a register value transfer sequence in order to implement a PATA/SATA bridge function.

The data buffer 70 buffers data transferred between the host 2 (PATA I/F) and the device 4 (SATA I/F). The data buffer 70 functions as a buffer (FIFO) which absorbs the difference in clock frequency between the PATA side and the SATA side. Specifically, when the PATA-side clock frequency is 50 MHz (or 60 MHz) and the SATA-side clock frequency is 37.5 MHz, for example, the difference in clock frequency can be absorbed by providing the data buffer 70. The data buffer 70 may be implemented by a dual-port memory (RAM) including a first port on the PATA I/F 10 side through which data is input and output at 50 MHz (first frequency) and a second port on the SATA I/F 50 side through which data is input and output at 37.5 MHz (second frequency), for example.

The PATA I/F 10 includes a task file register (hereinafter appropriately referred to as “TFR”) 12. The TFR 12 is a pseudo (virtual) register provided for a PATA/SATA bus bridge. The host 2 can read and write data as if the SATA device 4 were a PATA device by providing the TFR 12. Specifically, the host 2 can control the SATA device 4 using existing PATA firmware and software.

The SATA I/F 50 includes a shadow task file register (hereinafter appropriately referred to as “SFR”) 52. The SFR 52 is a register, a register value being transferred between the SFR 52 and TFR 12. The SFR 52 is a register defined in the SATA standard.

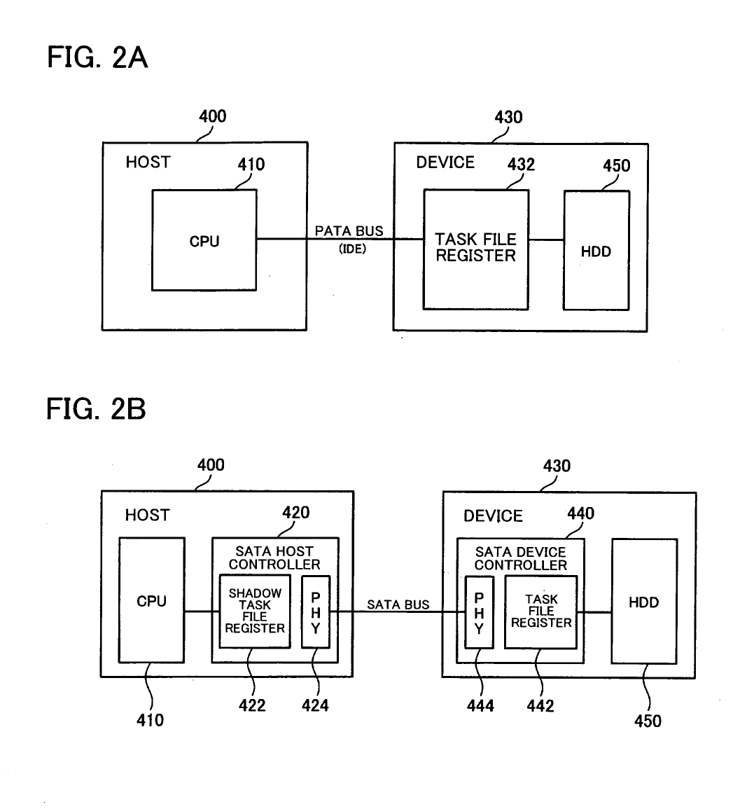

FIG. 2A shows a PATA (IDE) system configuration example, for example. In FIG. 2A, a CPU 410 included in a host 400 accesses a device-side task file register 432 through a PATA bus. Specifically, the task file register 432 is mapped onto an address space of the CPU 410. Software which operates on the CPU 410 directly reads/writes data from/into the device-side task file register 432 to control a device 430 including a hard disk drive (HDD) 450 and the like. The task file register 432 is also accessed by device-side firmware.

FIG. 2B shows a SATA system configuration example. In FIG. 2B, a host 400 includes a CPU 410 and a SATA host controller 420. The SATA host controller 420 includes a shadow task file register 422, a physical layer circuit (PHY) 424, and the like. A device 430 includes a SATA device controller 440 and an HDD 450. The SATA device controller 440 includes a task file register 442, a physical layer circuit (PHY) 444, and the like. Data is transferred between the physical layer circuit 424 of the SATA host controller 420 and the physical layer circuit 444 of the SATA device controller 440 through a SATA bus using small-amplitude differential signals.

In FIG. 2B, the host-side shadow task file register 422 is accessed by software which operates on the CPU 410, and the device-side task file register 442 is accessed by device-side firmware (HDD).

The SATA standard maintains software-level compatibility with the PATA (IDE) standard, and is characterized in that two task file registers are used. Specifically, the host (HBA)-side shadow task file register 422 and the device-side original task file register 442 are used. The SATA standard maintains software-level compatibility with the PATA (IDE) standard shown in FIG. 2A by performing communication control which transfers a register value between the registers 422 and 442 through the SATA bus.

In the data transfer control device according to this embodiment, the shadow task file register 52 shown in FIG. 1 corresponds to the host-side shadow task file register 422 shown in FIG. 2B, and the task file register 5 included in the device 4 shown in FIG. 1 corresponds to the device-side task file register 442 shown in FIG. 2B.

In FIG. 1, the task file register (TFR) 12 provided in the PATA I/F 10 is not a register defined in the SATA standard. The task file register (TFR) 12 is a pseudo (virtual) register provided for a PATA/SATA bridge. The host 2 (software which operates on CPU) identifies and accesses the register 12 as a PATA task file register, and writes/reads a register value into/from the register 12. Specifically, the host 2 identifies the register 12 in the same manner as the PATA (IDE) task file register 432 shown in FIG. 2A, and writes/reads a register value into/from the register 12. The sequence controller 30 transfers the register value of the task file register 12 to the shadow task file register 52, or transfers the register value of the shadow task file register 52 to the task file register 12.

According to this configuration, when the host 2 writes a register value into the PATA task file register 12, the register value is transferred to and written into the SATA shadow task file register 52, and is transferred to the device 4 through the SATA bus using an FIS. A register value written into the shadow task file register 52 using an FIS from the device 4 is transferred to the task file register 12, and is read by the host 2. Therefore, the host 2 can read and write data as if the SATA device 4 were a PATA device, whereby a PATA/SATA bridge function can be efficiently implemented.

According to the configuration shown in FIG. 1, even if the host 2 includes only the PATA I/F, the device 4 including the SATA I/F can be connected to the host 2 through the data transfer control device. Therefore, existing PATA (IDE) firmware and software can be utilized as firmware and software for the host 2. Specifically, the SATA device 4 can be connected to the host 2 without changing the hardware/software configuration of the host 2. This makes it possible to minimize an additional development period and development cost, whereby the development period and cost of an electronic instrument including the host 2 and the device 4 can be reduced. Since an ordinary commercial large-capacity HDD can be connected to the host 2 as the device 4, the capacity of a built-in HDD of electronic instruments can be increased.

Moreover, since a circuit board provided with the host 2 and a circuit board provided with the device 4 can be connected through a SATA bus (serial bus), the number of interconnects provided between the circuit boards can be reduced, whereby the size of an electronic instrument can be reduced.

2. Register Value Transfer

This embodiment employs the following method so that the host 2 can consider the SATA device 4 to be a PATA device.

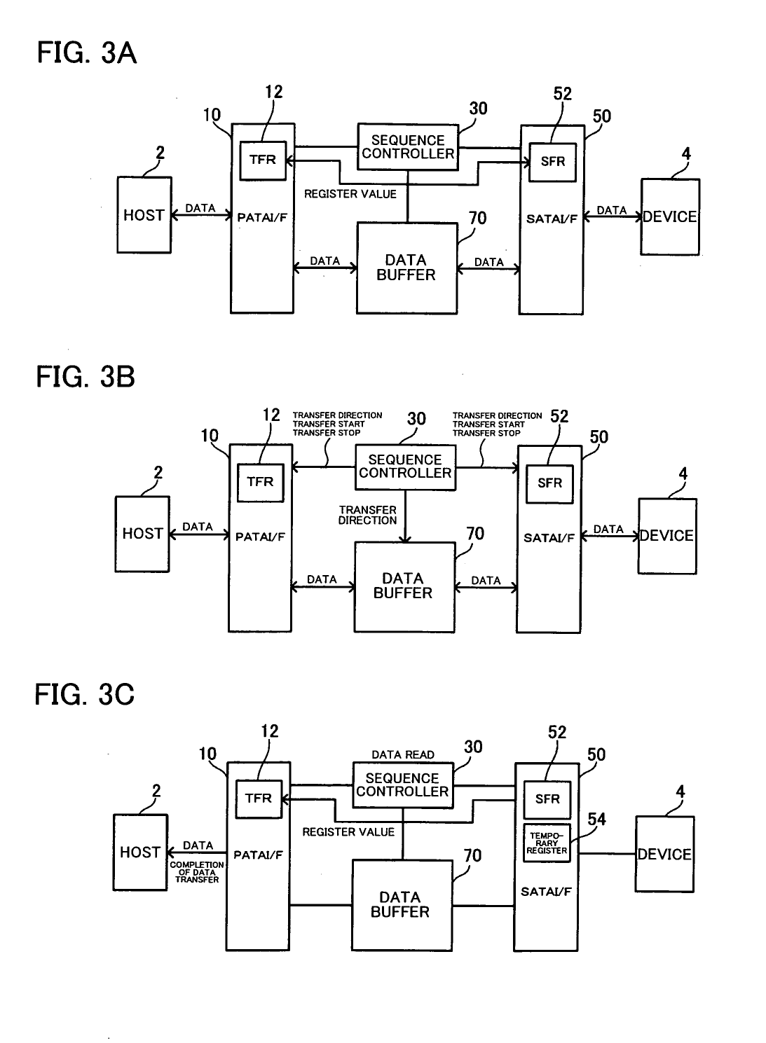

In FIG. 3A, the data buffer 70 buffers data transferred between the host 2 and the device 4, for example. Therefore, the actual data is transferred between the host 2 and the device 4 through the data buffer 70. Specifically, data is transferred between the host 2 and the device 4 through a transfer path including the PATA I/F 10, the data buffer 70, and the SATA I/F 50 under control of the sequence controller 30.

The sequence controller 30 controls a register value transfer sequence between the TFR 12 and the SFR 52. Specifically, the sequence controller 30 transfers a register value between the TFR 12 which is a pseudo register provided for a bridge and the SFR 52 conforming to the SATA standard. Specifically, a register value is transferred through a transfer path including the TFR 12, the sequence controller 30, and the SFR 52 under control of the sequence controller 30. According to this configuration, a register value written into the TFR 12 by the host 2 can be transferred (copied) from the TFR 12 to the SFR 52 and transferred to the device 4, or a register value written into the SFR 52 by the device 4 through the SATA bus (FIS) can be transferred (copied) from the SFR 52 to the TFR 12 and transferred to the host 2.

The sequence controller 30 can monitor a register value transferred between the TFR 12 and the SFR 52 by transferring a register value between the TFR 12 and the SFR 52 through the sequence controller 30. Therefore, data transfer through the transfer path including the PATA I/F 10, the data buffer 70, and the SATA I/F 50 can be appropriately controlled based on the monitoring result. Moreover, the sequence controller 30 can manage the register value transfer timing by transferring a register value through such a path. This makes it possible to appropriately control the register value transfer sequence which enables the host 2 to consider the SATA device 4 to be a PATA device.

In FIG. 3B, the sequence controller 30 controls a transfer sequence by outputting control signals such as a transfer start signal, a transfer stop signal, and a transfer direction setting signal to the PATA I/F 10 and the SATA I/F 50, for example.

Specifically, the sequence controller 30 determines the transfer direction based on received FIS information(e.g., FIS interrupt signal or transfer direction signal) from the SATA I/F 50, and outputs a signal which sets the transfer direction to the PATA I/F 10 and the SATA I/F 50. This enables the PATA I/F 10 and the SATA I/F 50 to identify the transfer direction, whereby appropriate data transfer can be implemented under control of the sequence controller 30.

The sequence controller 30 outputs the transfer start signal (Tran Go) to the PATA IF 10 and the SATA I/F 50 when starting transfer, and outputs the transfer stop signal (Tran Stop) to the PATA I/F 10 and the SATA I/F 50 when stopping transfer. This enables the PATA I/F 10 and the SATA I/F 50 to identify the transfer start timing and the transfer stop. timing, whereby appropriate data transfer can be implemented under control of the sequence controller 30.

In FIG. 3B, the sequence controller 30 controls the transfer sequence by outputting the transfer direction setting signal to the data buffer 70. Specifically, the sequence controller 30 does not output the transfer start signal and the transfer stop signal to the data buffer 70. In this case, data transfer (FIFO control) can also be appropriately implemented using a control signal (REQ or ACK) transferred between the PATA I/F 10 and the data buffer 70 or transferred between the SATA I/F and the data buffer 70. Therefore, the transfer sequence control can be simplified, whereby the circuit scale can be reduced.

This embodiment is also characterized in that the register value transfer timing is controlled without immediately transferring a register value written into one of the TFR 12, the SFR 52, and the like to the other.

As shown in FIG. 3C, when the host 2 reads data from the device 4, the sequence controller 30 sets (writes) a register value in the TFR 12 after data transfer (data output) from the PATA I/F 10 to the host 2 has been completed, for example. For example, the sequence controller 30 transfers (writes) a register value (e.g., Status) of the SFR 52 to the TFR 12 or transfers (writes) a register value (e.g., E_Status) stored in a temporary register 54 of the SATA I/F 50 to the TFR 12 after the PATA I/F 10 has completed data transfer.

Specifically, when the PATA I/F 10 has completely output data to the PATA bus, the PATA I/F 10 issues an interrupt (activates an interrupt signal) to the sequence controller 30. The sequence controller 30 transfers a register value of the SFR 52 or a register value of the temporary register 54 to the TFR 12 after confirming that data transfer has been completed utilizing such an interrupt.

According to this configuration, the register value of the TFR 12 is rewritten and the host 2 is notified of the register value of the TFR 12 after the sequence controller 30 has confirmed that all data transfers have been completed and data does not remain in the data transfer control device. This prevents a situation in which the data read operation of the host 2 stops before completion of data transfer, whereby the data remains in the data transfer control device, for example.

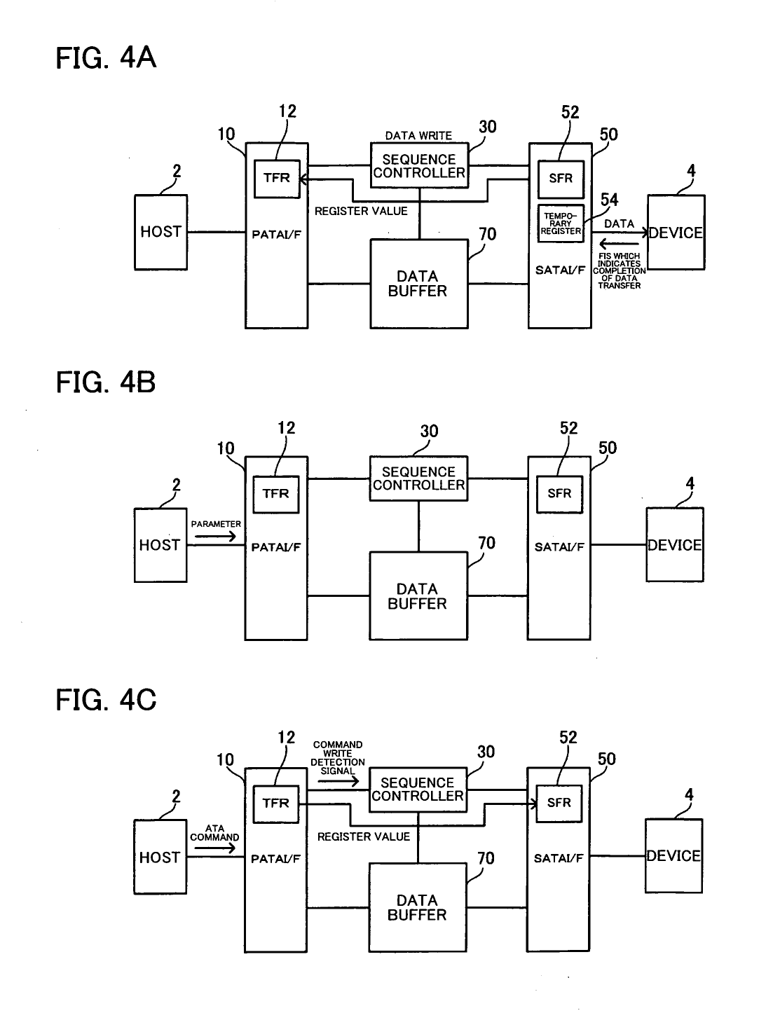

As shown in FIG. 4A, when the host 2 writes data into the device 4, the sequence controller 30 sets (writes) a register value in the TFR 12 after receiving an FIS which indicates completion of data transfer through the SATA bus from the device 4. For example, the sequence controller 30 transfers (writes) a register value (e.g., Status) of the SFR 52 to the TFR 12 or transfers (writes) a register value (e.g., E_Status) stored in the temporary register 54 of the SATA I/F 50 to the TFR 12 after receiving an FIS which indicates completion of data transfer.

According to this configuration, the register value of the TFR 12 is rewritten and the host 2 is notified of the register value of the TFR 12 after the sequence controller 30 has confirmed that all data transfers to the device 4 have been completed and data does not remain in the data transfer control device utilizing the FIS received from the device 4. This prevents a situation in which the data write operation of the host 2 stops before completion of data transfer to the device 4, whereby the data cannot be completely transferred to the device 4 from the host 2, for example.

In this embodiment, the sequence controller 30 transfers (updates) a register value from the TFR 12 to the SFR 52 on condition that a parameter (command parameter) has been written into the TFR 12, as shown in FIG. 4B, and then an ATA command has been written into the TFR 12, as shown in FIG. 4C. Specifically, a command write detection signal becomes active when an ATA command has been written into the TFR 12. When the command write detection signal has become active, the sequence controller 30 transfers a register value from the TFR 12 to the SFR 52.

Specifically, before writing an ATA command, the host 2 writes a parameter relating to that ATA command into the TFR 12 through the PATA bus. The sequence controller 30 does not transfer a register value from the TFR 12 to the SFR 52 at the timing at which the parameter has been written.

When the host 2 has written an ATA command (e.g., PIO read, PIO write, DMA read, DMA write, or no-data command) into the TFR 12 after writing the parameter, the command write detection signal becomes active and is output to the sequence controller 30. The sequence controller 30 transfers (writes) the register value indicated by the parameter and the ATA command written into the TFR 12 to the SFR 52.

This enables the register value to be transferred when the ATA command has been written. Therefore, the transfer process can be simplified while reducing the number of signal lines necessary for the transfer process, whereby the circuit scale can be reduced and the process can be simplified.

Specifically, when employing a method in which the register value is also transferred when the parameter has been written, the register value must be transferred two or more times, whereby the process becomes complicated. Moreover, since a parameter write detection signal is necessary, the number of signal lines increases.

On the other hand, the software of the host 2 created for the PATA (IDE) standard is generally designed so that an ATA command is written after writing a parameter. In this embodiment, the register value is transferred from the TFR 12 to the SFR 52 at the timing at which the software of the host 2 has written the ATA command after writing the parameter, taking the above point into consideration. This makes it possible to directly utilize PATA software and to simplify the transfer process, whereby the size of the data transfer control device can be reduced.

3. Detailed Configuration Example

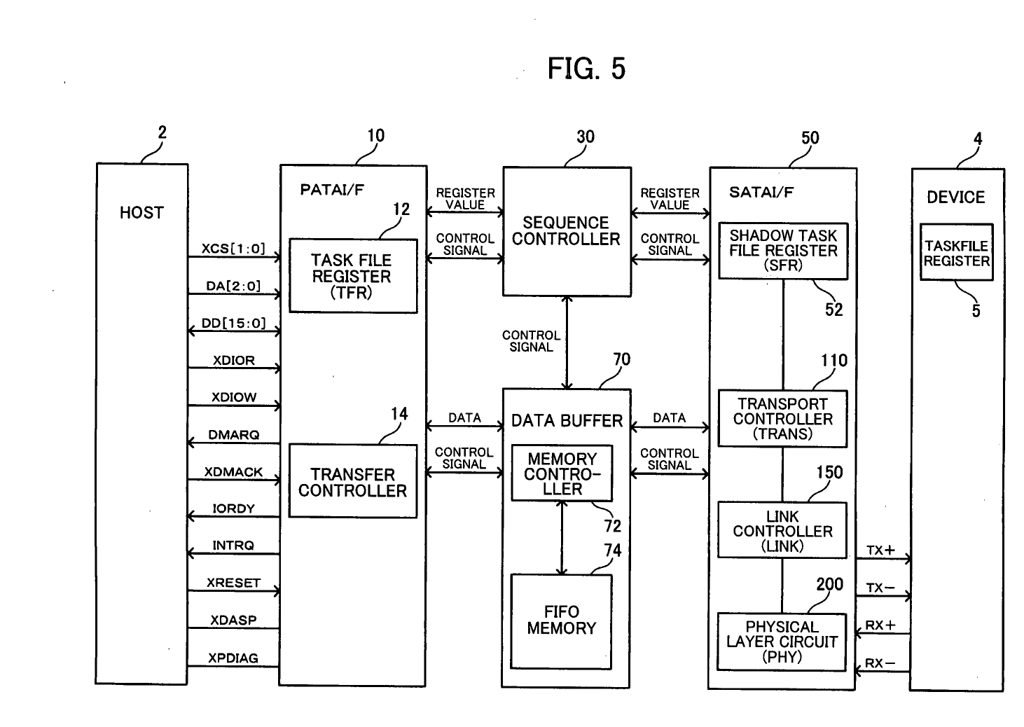

FIG. 5 shows a detailed configuration example of the data transfer control device. The PATA I/F 10 includes the TFR 12 and a transfer controller 14.

The transfer controller 14 implements a PATA(IDE) interface using PATA signals XCS to XPDIAG, and controls data transfer between the PATA I/F 10 and the data buffer 70 using a data transfer control signal.

The data buffer 70 includes a memory controller 72 and a FIFO memory (FIFO RAM) 74. The memory controller 72 controls writing and reading of data into and from the FIFO memory 74. The memory controller 72 also controls data transfer between the data buffer 70 and the PATA I/F 10 or the SATA I/F 50 using control signals such as an REQ signal and an ACK signal.

The SATA I/F 50 includes the SFR 52, a transport controller 110, a link controller 150, and a physical layer circuit 200.

The transport controller 110, the link controller 150, and the physical layer circuit 200 are circuits which respectively perform a transport layer process, a link layer process, and a physical layer process defined in the SATA standard.

4. PATA I/F

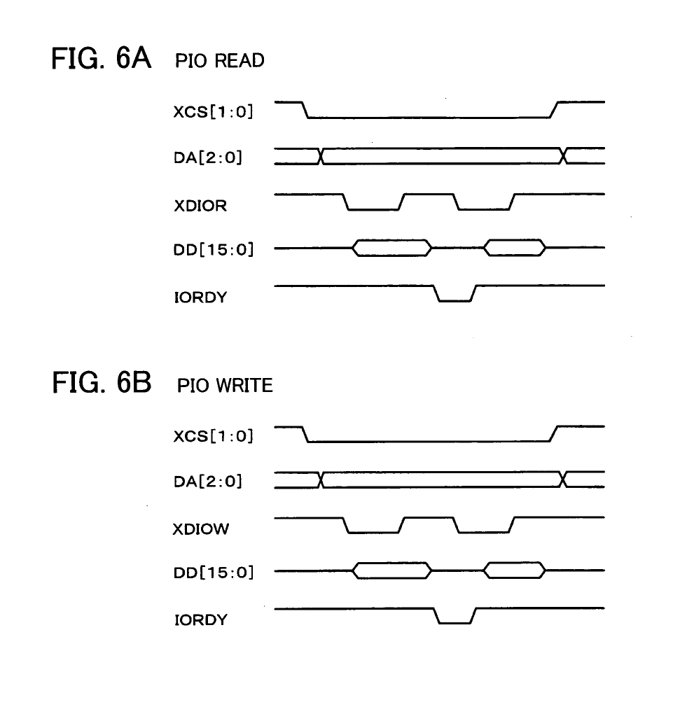

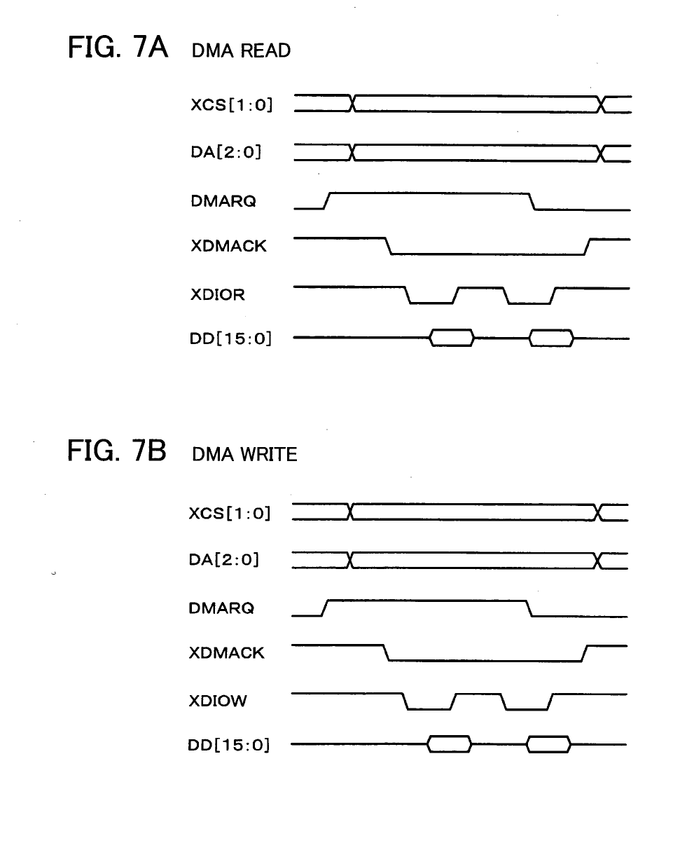

The data transfer process of the PATA I/F 10 is described below with reference to the configuration shown in FIG. 5 and signal waveforms shown in FIGS. 6A to 7B.

A signal XCS[1:0] is a chip select signal used to access each PATA register. A signal DA[2:0] is an address signal used to access data or a data port. Signals DMARQ and DMACK are signals used for DMA transfer. The device activates (asserts) the signal DMARQ when preparations for data transfer have been completed, and the host activates the signal DMACK in response to the signal DMARQ.

A signal XDIOW is a write signal used to write data into a register or a data port. A signal XDIOR is a read signal used to read data from a register or a data port. A signal IORDY is used as a wait signal or the like when device-side data transfer preparations have not been completed.

A signal INTRQ is a signal used for the device to request an interrupt to the host. When the host has read the information in a status register of the device-side TFR 12 after the signal INTRQ has become active, the device inactivates (negates) the signal INTRQ after a specific period of time has expired. The device can notify the host of completion of a command process using the signal INTRQ.

FIGS. 6A and 6B show signal waveform examples during PIO (programmed I/O) read and PIO write. Data is read from the status register of the PATA TFR 12 by PIO read shown in FIG. 6A, and data is written into a command register by PIO write shown in FIG. 6B. For example, issuance of an ATA command by the host 2 may be implemented by PIO write.

FIGS. 7A and 7B show signal waveform examples during DMA read and DMA write. The device (data transfer control device) activates the signal DMARQ when preparations for data transfer have been completed. The host activates the signal DMACK in response to the signal DMARQ to initiate DMA transfer. The host then performs DMA transfer of data DD[15:0] using the signal XDIOR (during read) or XDIOW (during write).

5. SATA I/F

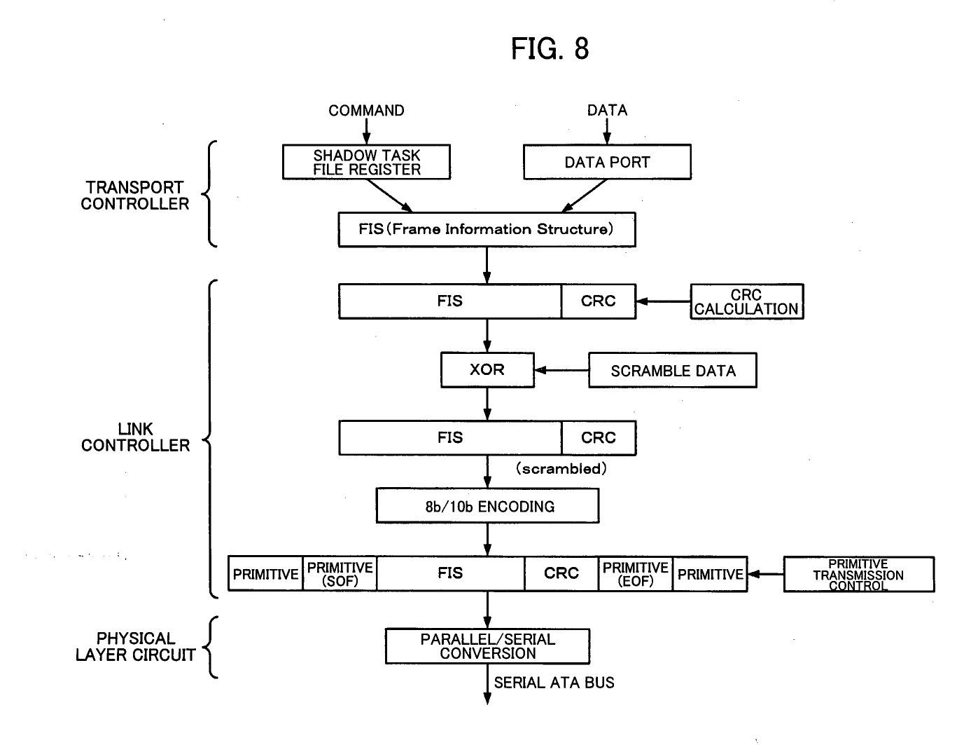

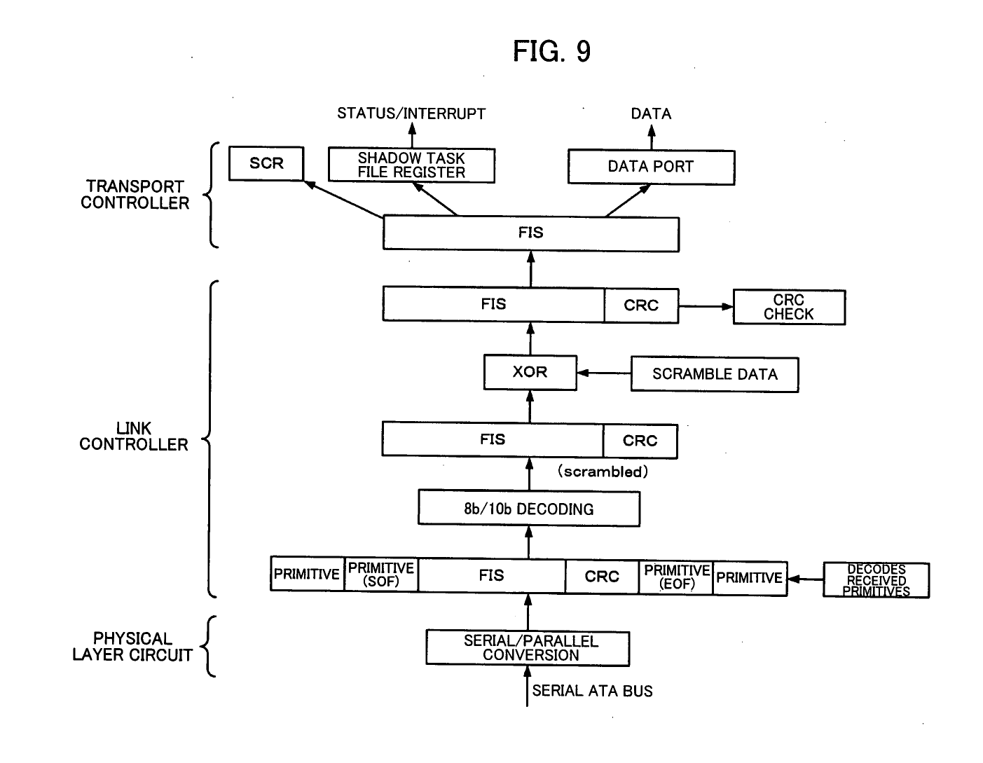

The data transfer process of the SATA I/F 50 is described below. FIG. 8 shows the flow of a SATA transmitter-side data transfer process, and FIG. 9 shows the flow of a receiver-side data transfer process.

As shown in FIG. 8, the transmitter-side transport controller (transport layer) generates an FIS based on a command written into the shadow task file register and data input to the data port. The FIS is a payload of a frame, and is formed in Dword (32 bits) units. The frame is an information unit exchanged between the host and the device. The frame includes a start of frame (SOF) primitive, an FIS, a cyclic redundancy check (CRC) calculated for the FIS, and an end of frame (EOF) primitive.

The transmitter-side link controller calculates the CRC for the FIS and adds the CRC to the end of the FIS. The transmitter-side link controller performs a scramble process which calculates the exclusive OR (XOR) of the FIS, the CRC, and scramble data. The transmitter-side link controller 8b/10b-encodes the FIS and CRC thus scrambled. The term “8b/10b encoding” refers to a data transmission encoding algorithm which converts 8-bit data into a 10-bit transmission character. 8b/10b encoding ensures successive transmission by adjusting the number of 1 and 0 in a symbol string. The primitives such as the SOF primitive and the EOF primitive are added to the 8b/10b-encoded FIS and CRC.

The transmitter-side physical layer circuit converts the parallel data from the link controller into serial data, and transmits the serial data to the SATA bus using small-amplitude differential signals.

As shown in FIG. 9, the receiver-side physical layer circuit converts the serial data received through the SATA bus into parallel data.

The receiver-side link controller decodes the primitives added to the FIS and the CRC. The receiver-side link controller 8b/10b-decodes the FIS and the CRC. Specifically, the receiver-side link controller converts the 10-bit transmission character into 8-bit data. The receiver-side link controller then performs a descramble process which calculates the exclusive OR of the scrambled FIS and CRC and scramble data. The receiver-side link controller checks the CRC added to the end of the FIS.

The receiver-side transport controller writes the FIS command into the shadow task file register to output the status and interrupt, and outputs data through the data port.

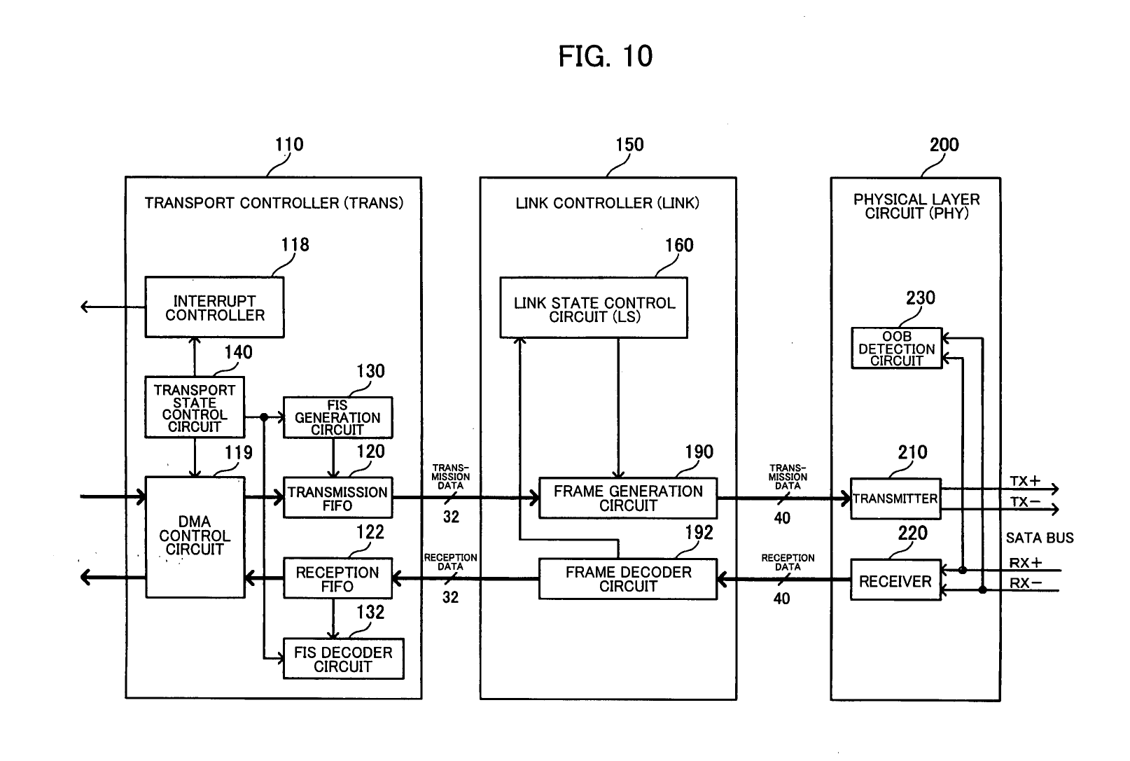

FIG. 10 shows a configuration example of the SATA I/F 50. Note that the configuration of the SATA I/F 50 is not limited to the configuration shown in FIG. 10. Various modification may be made such as omitting some elements or adding other elements. For example, the SATA I/F 50 may have a configuration in which the physical layer circuit 200 is omitted.

In the SATA standard, data is processed in 32 bit units. The link controller 150 8b/10b-encodes 32-bit data into 40-bit data, and transmits the 40-bit data to the physical layer circuit 200. The physical layer circuit 200 serializes the 40-bit data, and transmits the serialized data to a SATA cable. When receiving data, the physical layer circuit 200 converts serial data into 40-bit data, and the link controller 150 converts the 40-bit data into 32-bit data, and transmits the 32-bit data to the transport controller 110.

The transport controller 110 performs control of the transport layer. Specifically, the transport controller 110 performs the following process when receiving an FIS transmission request from the upper-level layer (application layer).

Specifically, the transport controller 110 collects the information of the FIS based on the FIS type requirement. The transport controller 110 disposes information to be transmitted in a defined format in FIS type units. The transport controller 110 then notifies the link controller 150 of the transmission request. This causes the link controller 150 to transmit a signal X_RDY. When the transport controller 110 has received a signal R_RDY from the partner node and received a reception acknowledgement from the link controller 150, the transport controller 110 transfers the FIS to the link controller 150. The transport controller 110 manages the flow of a transmission FIFO 120, and notifies the link controller 150 of necessary flow control. When the transport controller 110 has received the transmission result from the link controller 150, the transport controller 110 notifies the upper-level layer of the transmission result, if necessary.

The transport controller 110 performs the following process when the transport controller 110 has received an FIS from the link controller 150.

When the transport controller 110 has received an FIS from the link controller 150, the transport controller 110 determines the type of the received FIS. The transport controller 110 transfers data to a register and a FIFO appropriate for the type of the FIS. The transport controller 110 manages the flow of a reception FIFO 122, and notifies the link controller 150 of necessary flow control. The transport controller 110 then notifies the link controller 150 and the upper-level layer (application layer) of the reception result.

The link controller 150 performs control of the link layer. Specifically, the link controller 150 performs the following process during transmission.

The link controller 150 receives data (FIS) from the transport controller 110. The link controller 150 generates a CRC for the FIS, and adds the CRC to the end of the FIS. The link controller 150 then scrambles the data, and performs 8b/10b encoding. The link controller 150 transmits the primitives and the FIS according to the SATA communication protocol. The link controller 150 notifies the transport controller 110 of the transmission result.

The link controller 150 performs the following process during reception. Specifically, the link controller 150 receives an 8b/10b-encoded character from the physical layer circuit 200. The link controller 150 decodes the 8b/10b-encoded character, and notifies the processing section and the like of the decoded primitives. The link controller 150 then descrambles the decoded FIS, and checks the CRC. The link controller 150 transfers the data to the transport controller 110. The link controller 150 notifies the transport controller 110 of the decoding result and the CRC check result.

The physical layer circuit 200 is an analog front-end circuit which implements the physical layer. The physical layer circuit 200 transmits and receives serial data (serial stream), converts the serial data into parallel data, and converts the parallel data into serial data. The physical layer circuit 200 detects an 8b/10b K28.5 character, and detects and transmits an out-of-band (OOB) signal. The physical layer circuit 200 provides a device status (presence or absence, transfer state, and power state of the device), and provides a communication control interface (transfer rate control and loop back). The physical layer circuit 200 optionally performs power management.

The physical layer circuit (PHY) 200 includes a transmitter (driver) 210, a receiver 220, an OOB detection circuit 230, and the like.

The transmitter 210 transmits serial data (packet) through differential signal lines (differential signal line pair) TX±, and the receiver 220 receives serial data (packet) through differential signal lines (differential signal line pair) RX±. A serial stream is transferred through the SATA bus (serial bus in a broad sense) of the differential signal lines TX± and RX± using NRZ differential signals having an amplitude voltage of ±250 mV.

The OOB detection circuit 230 detects the OOB signal. The OOB signal is a signal which controls reset/initialization of the SATA interface, establishment of communication, and speed negotiation.

The link controller 150 includes a link state control circuit 160, a frame generation circuit 190, and a frame decoder circuit 192.

The link state control circuit 160 controls the state of the link controller 150. For example, the link state control circuit 160 performs a transition process between states such as a reset state, an idle state, a transmission state, and a reception state, for example.

The frame generation circuit 190 generates a frame based on transmission data (FIS) from the transport controller 110, a transmission control signal from the link state control circuit 160, and the like. Specifically, the frame generation circuit 190 calculates the CRC of the FIS from the transport controller 110, and performs the scrambling process, the 8b/10b encoding process, the process of generating and adding the primitives, and the like.

The frame decoder circuit 192 analyzes (deassembles) the received frame, and outputs a reception analysis signal (e.g., power-down request signal) to the link state control circuit 160. Specifically, the frame decoder circuit 192 analyzes the primitives added to the FIS, and performs the 8b/10b decoding process, the descrambling process, the process of calculating and checking the CRC, and the like.

The transport controller 110 includes an interrupt controller 118, a DMA control circuit 119, a transmission FIFO 120, a reception FIFO 122, an FIS generation circuit 130, an FIS decoder circuit 132, and a transport state control circuit 140.

The interrupt controller 118 generates an interrupt signal for indicating the received FIS information from the device 4 and the like. The DMA control circuit 119 controls DMA transfer of transmission data and reception data (contents and data) contained in the FIS. The transmission FIFO 120 is a FIFO which serves as a buffer for the transmission data from the DMA control circuit 119. The reception FIFO122 is a FIFO which serves as a buffer for the reception data from the link controller 150. The FIS generation circuit 130 is a circuit which generates the FIS. The FIS decoder circuit 132 is a circuit which analyzes the FIS. The transport state control circuit 140 controls the state of the transport controller 110.

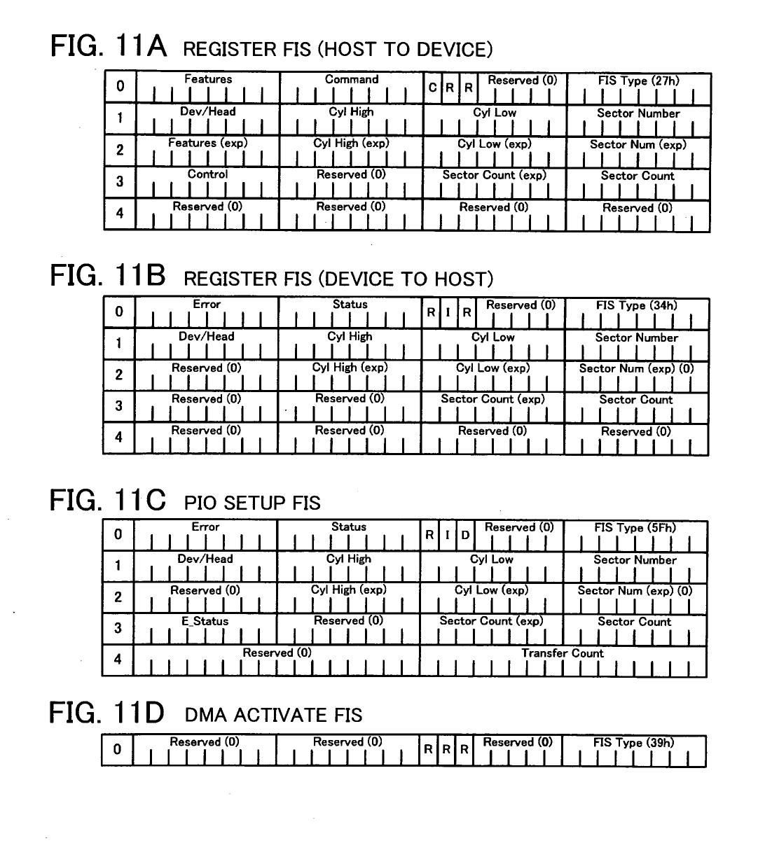

FIGS. 11A to 11D show format examples of the FIS transmitted and received by the SATA I/F 50. FIG. 11A shows the format of a register FIS from the host to the device, FIG. 11B shows the format of a register FIS from the device to the host, FIG. 11C shows the format of a PIO setup FIS, and FIG. 11D shows the format of a DMA activate FIS.

6. Sequence Controller

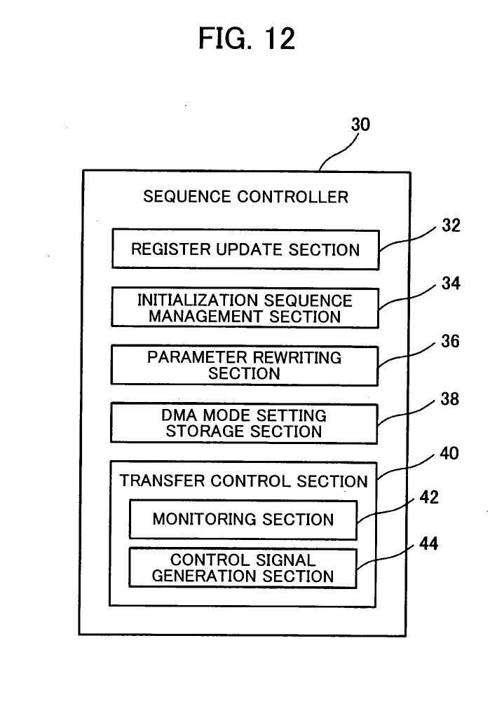

FIG. 12 shows a configuration example of the sequence controller 30. The sequence controller 30 includes a register update section 32, an initialization sequence management section 34, a parameter rewriting section 36, a DMA mode setting storage section 38, and a transfer control section 40. The configuration of the sequence controller 30 is not limited to the configuration shown in FIG. 12. Various modification may be made such as omitting some elements or adding other elements.

The register update section 32 updates the register values of the TFR 12 (task file register) and the SFR 52 (shadow task file register). Specifically, the register update section 32 transfers the register value of the TFR 12 to the SFR 52 to update the register value of the SFR 52, or transfers the register value of the SFR 52 to the TFR 12 to update the register value of the TFR 12.

For example, when the host 2 has written an ATA command into the TFR 12, the PATA I/F 10 activates the command write detection signal. When the command write detection signal has become active, the register update section 32 transfers the register value of the TFR 12 to the SFR 52.

The SATA I/F 50 decodes the FIS received from the device 4, and generates and outputs an interrupt signal (received FIS information in a broad sense) which indicates the type of the FIS based on the decoding result. The register update section 32 determines the type of the received FIS based on the interrupt signal, and transfers the register value from the SFR 52 to the TFR 12 to update the register value, for example.

The initialization sequence management section 34 manages an initialization sequence accompanying a hardware reset (HRST) and a soft reset (SRST). Specifically, the initialization sequence management section 34 monitors a setting such as a master or a slave to manage the PATA initialization sequence.

The parameter rewriting section 36 rewrites a parameter when the host 2 has issued an identify device command to the device 4 and the parameter rewriting section 36 has received a parameter of the device information from the device 4. Specifically, the parameter rewriting section 36 rewrites a parameter such as the transfer rate with a parameter which can be dealt with.

When the host 2 has issued a set feature command, the DMA mode setting storage section 38 analyzes the set feature command, and stores the DMA transfer mode setting.

The transfer control section 40 controls the data transfer sequence of the data transfer control device. The transfer control section 40 includes a monitoring section 42 and a control signal generation section 44. The monitoring section 42 monitors signals such as the command write detection signal from the PATA I/F 10 and the interrupt signal (received FIS information) from the SATA I/F 50. The control signal generation section 44 generates control signals such as the transfer direction setting signal, the transfer start signal, and the transfer stop signal based on the monitoring result, and controls the transfer sequence by outputting the control signals to the PATA I/F 10, the data buffer 70, and the SATA I/F 50. The control signal generation section 44 outputs only the transfer direction setting signal to the data buffer 70 without outputting the transfer start signal and the transfer stop signal.

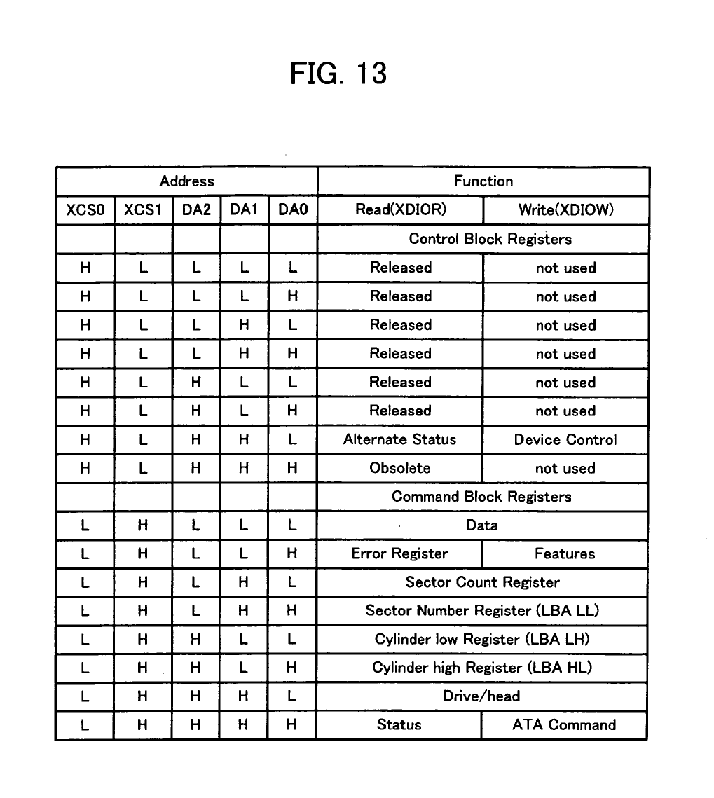

FIG. 13 shows a format example of the ATA task file register. The task file register includes a control block register and a command block register. The control block register is selected when chip select signals XCS0 and XCS1 are respectively set at the H level (negated) and the L level (asserted), and the command block register is selected when the chip select signals XCS0 and XCS1 are respectively set at the L level and the H level. The command block register includes a status register (Status) and an ATA command register (ATA Command).

7. PIO Transfer and DMA Transfer

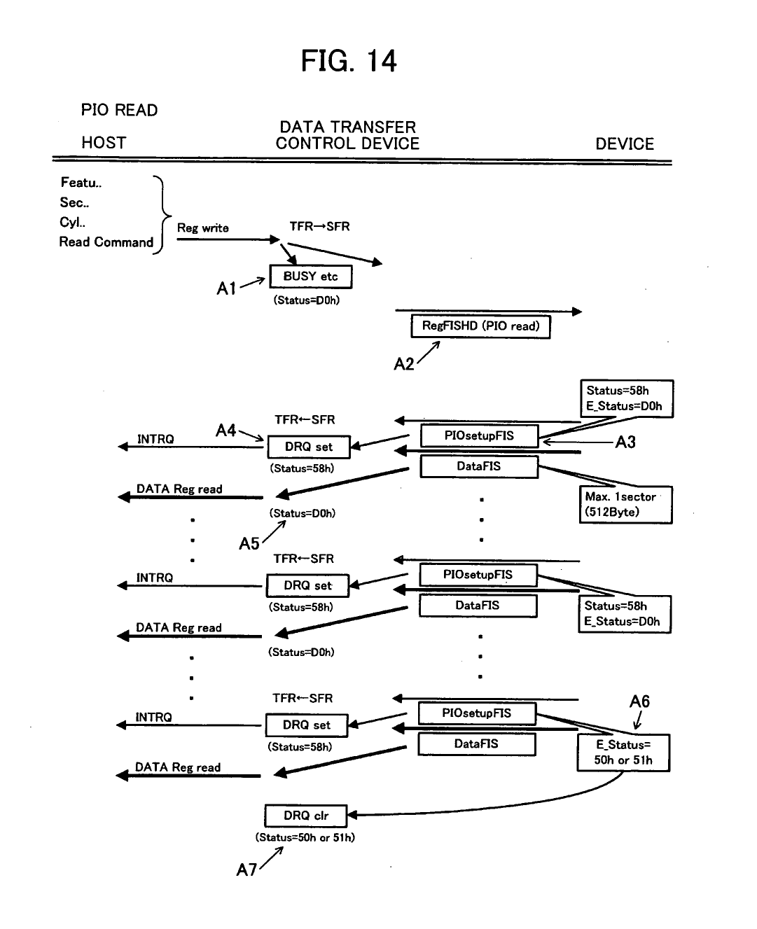

The details of PIO transfer and DMA transfer implemented by the data transfer control device according to this embodiment are described below with reference to FIGS. 14 to 17.

FIG. 14 is a PIO read transfer sequence diagram. When the host 2 has issued a PIO read command, the status register of the TFR 12 is set at D0h, as indicated by A1 in FIG. 14. Specifically, the PATA I/F 10 sets a BUSY bit at one to notify the host 2 that the device 4 is in a busy state. The sequence controller 30 transfers (copies) the register value of the TFR 12 to the SFR 52. As indicated by A2, the SATA I/F 50 creates a register FIS (Host to Device) including the PIO read command based on the register value of the SFR 52, and transmits the register FIS to the device 4 through the SATA bus.

The device 4 which has received the register FIS transmits a PIO setup FIS, as indicated by A3. In this case, 58h is set as a Status value of the PIO setup FIS shown in FIG. 1C, and D0h is set as an E_Status value. As shown in FIG. 18, the BUSY bit is set at 1 when D0h is set, and a DRQ bit is set at 1 when 58h is set. The BUSY bits and the DRQ bits are cleared to 0 when 50h is set. The E_Status value is stored in the temporary register of the SATA I/F 50, for example.

The sequence controller 30 receives the PIO setup FIS from the device 4. When a direction parameter D (see FIG. 11C) is the direction from the device to the host, the sequence controller 30 determines that the command issued by the host 2 is a PIO read command. The sequence controller 30 transfers the register value from the SFR 52 to the TFR 12, and sets the status register of the TFR 12 at 58h to set the DRQ bit at 1, as indicated by A4. This causes an interrupt INTRQ to the host 2 to occur. Note that polling by the host 2 may be employed instead of the interrupt INTRQ.

When the sequence controller 30 has received a data FIS from the device 4 and the host 2 has read data, the E_Status value (D0h) of the PIO setup FIS is set in the status register of the TFR 12 so that the BUSY bit is set at 1, as indicated by A5. Specifically, the E_Status value (D0h) stored in the temporary register of the SATA I/F 50 is transferred (written) to the status register of the TFR 12. This notifies the host 2 that the device 4 is in a busy state.

The PIO read operation of each sector is repeated in the above-described manner. As indicated by A6, the E_Status value is set at 50h or 51h in the PIO setup FIS of the final sector. Therefore, the E_Status value (50h or 51h) is set in the status register of the TFR 12 so that the DRQ bit is cleared, as indicated by A7. The host 2 is thus notified that all data transfers have been completed.

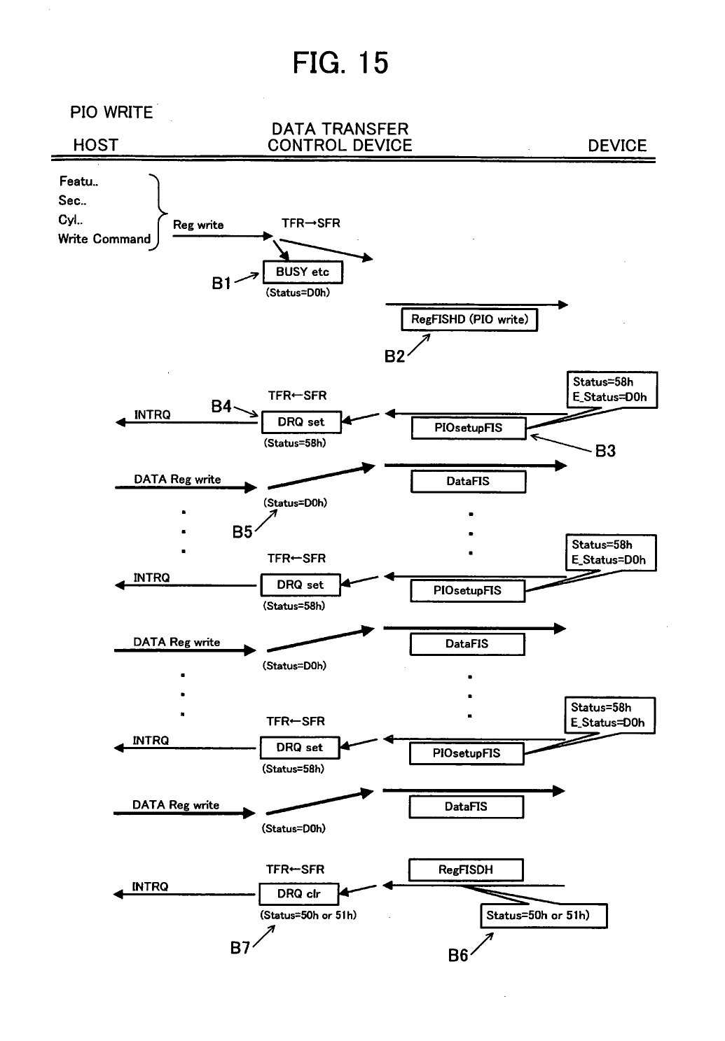

FIG. 15 is a PIO write transfer sequence diagram. When the host 2 has issued a PIO write command, the BUSY bit is set at 1 (D0h), as indicated by B1. The register value of the TFR 12 is transferred to the SFR 52, and a register FIS including the PIO write command is transmitted to the device 4, as indicated by B2.

The device 4 which has received the register FIS transmits a PIO setup FIS, as indicated by B3. The sequence controller 30 receives the PIO setup FIS from the device 4. When the direction parameter D (see FIG. 11C) is the direction from the host to the device, the sequence controller 30 determines that the command issued by the host 2 is a PIO write command. The sequence controller 30 transfers the register value from the SFR 52 to the TFR 12, and sets the status register of the TFR 12 at 58h to set the DRQ bit at 1, as indicated by B4. This causes the interrupt INTRQ to the host 2 to occur.

When the host 2 has written data, the E_Status value (D0h) of the PIO setup FIS is set in the status register of the TFR 12.

The PIO write operation of each sector is repeated in the above-described manner. When transfer of the final sector has been completed, the device 4 transmits a register FIS, as indicated by B6. The Status value (50h or 51h) of the register FIS is transferred from the SFR 52 to the TFR 12 so that the DRQ bit is cleared, as indicated by B7.

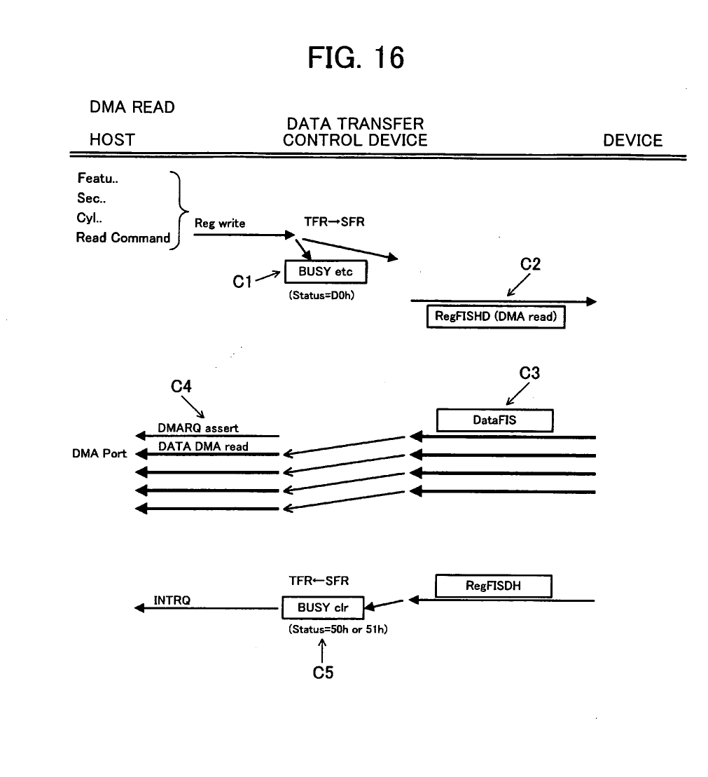

FIG. 16 is a DMA read transfer sequence diagram. When the host 2 has issued a DMA write command, the BUSY bit is set at 1 (D0h), as indicated by C1. In DMA transfer, the BUSY bit remains set at 1 during data transfer, differing from PIO transfer. The register value of the TFR 12 is transferred to the SFR 52, and a register FIS including the DMA read command is transmitted to the device 4, as indicated by C2.

The device 4 which has received the register FIS transmits a data FIS, as indicated by C3. When the FIS received from the device 4 is a data FIS, the sequence controller 30 determines that the command issued by the host 2 is a DMA read command. As indicated by C4, the signal DMARQ (see FIG. 7A) is asserted so that DMA transfer starts, and the data stored in the device 4 is read into the host 2.

When DMA transfer has been completed and the device 4 has transmitted a register FIS, the register value of the SFR 52 is transferred to the TFR 12 so that the BUSY bit is cleared (50h or 51h), as indicated by C5.

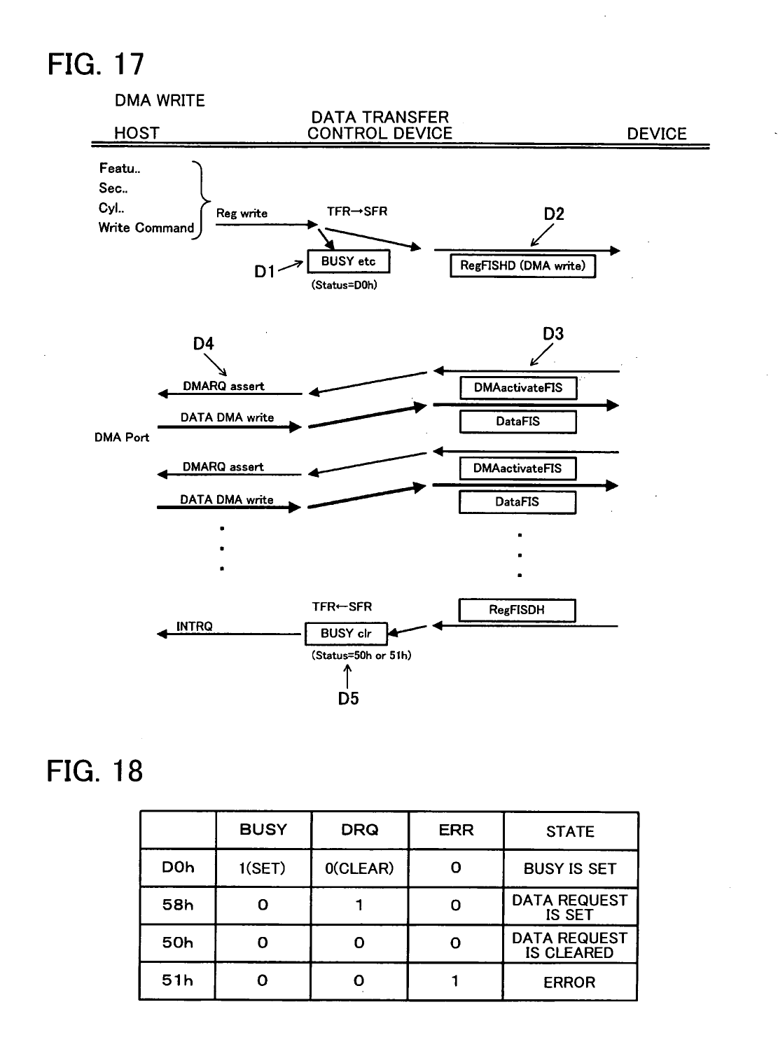

FIG. 17 is a DMA write transfer sequence diagram. When the host 2 has issued a DMA write command, the BUSY bit is set at 1 (D0h), as indicated by D1. The register value of the TFR 12 is transferred to the SFR 52, and a register FIS including the DMA write command is transmitted to the device 4, as indicated by D2.

The device 4 which has received the register FIS transmits a DMA activate FIS, as indicated by D3. When the FIS received from the device 4 is a DMA activate FIS, the sequence controller 30 determines that the command issued by the host 2 is a DMA write command. As indicated by D4, the signal DMARQ (see FIG. 7B) is asserted so that DMA transfer starts, and the data stored in the host 2 is written into the device 4.

When DMA transfer has been completed and the device 4 has transmitted a register FIS, the register value of the SFR 52 is transferred to the TFR 12 so that the BUSY bit is cleared (50h or 51h), as indicated by D5.

8. Detailed Operation

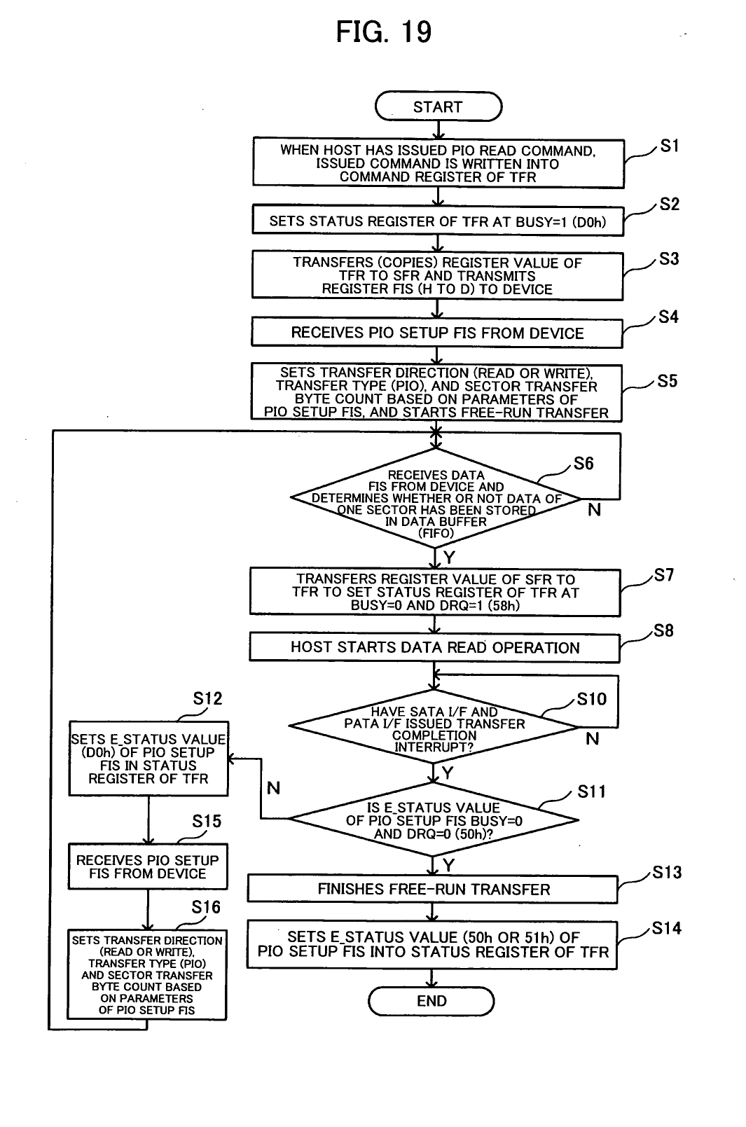

The detailed operation of the data transfer control device according to this embodiment is described below using flowcharts shown in FIGS. 19 to 22.

FIG. 19 is a flowchart of PIO read described with reference to FIG. 14. When the host 2 has issued a PIO read command, the issued command is written into the command register of the TFR 12 (step S1). The data transfer control device (PATA I/F) sets the status register of the TFR 12 at BUSY=1 (D0h) (step S2). The data transfer control device transfers (copies) the register value of the TFR 12 to the SFR 52, and transmits a register FIS (Host to Device) to the device (step S3).

The data transfer control device receives a PIO setup FIS from the device 4 (step S4). The data transfer control device sets the transfer direction (read or write), the transfer type (PIO), the transfer byte count of each sector (e.g., 512 bytes) based on parameters of the received PIO setup FIS, and starts free-run transfer in which the total data transfer count (total sector count) is not managed (step S5).

The data transfer control device receives a data FIS from device 4, and determines whether or not data of at least one sector has been stored in the data buffer 70 (FIFO) (step S6). When the data transfer control device has determined that data of at least one sector has been stored in the data buffer 70, the data transfer control device transfers the register value of the SFR 52 to the TFR 12 to set the status register of the TFR 12 at BUSY=0 and DRQ=1 (58h) (step S2).

When the DRQ bit (data request) has been set at 1, the host 2 starts a PIO data read operation (step S8). The data transfer control device (sequence controller) determines whether or not the SATA I/F 50 and the PATA I/F 10 have issued a transfer completion interrupt (step S10).

When the transfer completion interrupt has occurred, the data transfer control device determines whether or not the E_Status value of the PIO setup FIS is BUSY=0 and DRQ=0 (50h or 51h) (step S11). When the data transfer control device has determined that the BUSY is not 0 and the DRQ bit is not 0, the data transfer control device sets the E_Status value (D0h) of the PIO setup FIS in the status register of the TFR 12 (step S12). When the data transfer control device has received a PIO setup FIS from the device (step S15), the data transfer control device sets the transfer direction (read or write), the transfer type (PIO), the sector transfer byte count (step S16), and returns to the step S6.

When the data transfer control device has determined that BUSY=0 and DRQ=0 (50h), the data transfer control device finishes free-run transfer (step S13). The data transfer control device sets the E_Status value (BUSY=0 and DRQ=0 (50h)) in the status register of the TFR 12 (step S14).

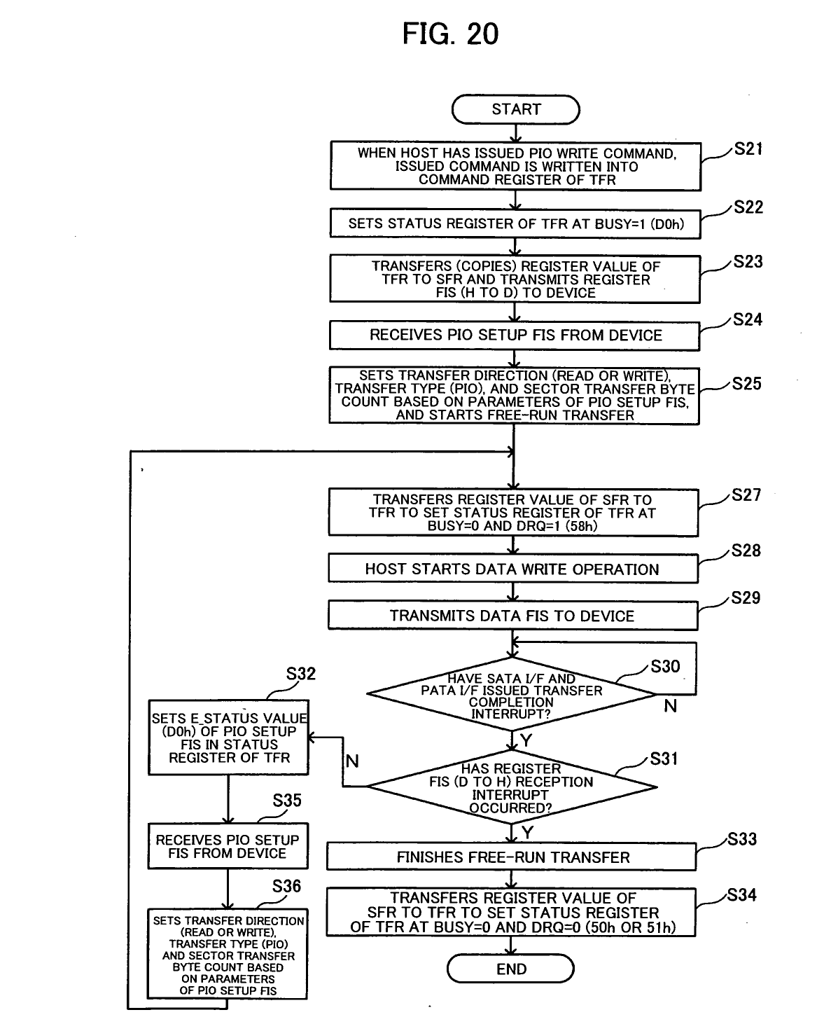

FIG. 20 is a flowchart of PIO write described with reference to FIG. 15. Steps S21 to S25 in FIG. 20 are the same as the steps S1 to S5 in FIG. 19. In FIG. 20, after starting free-run transfer, the data transfer control device transfers the register value of the SFR 52 to the TFR 12 to set the status register of the TFR 12 at BUSY=0 and DRQ=1 (58h) without checking whether or not data has been stored in the data buffer 70 (step S27).

When the DRQ bit has been set at 1, the host 2 starts a PIO data write operation (step S28). The data transfer control device transmits a data FIS to the device 4 (step S29). The data transfer control device determines whether or not the SATA I/F 50 and the PATA I/F 10 have issued a transfer completion interrupt (step S30).

When the transfer completion interrupt has occurred, the data transfer control device determines whether or not a register FIS (Device to Host) reception interrupt has occurred (step S31). Specifically, when the SATA I/F 50 has received a register FIS, the SATA I/F 50 outputs an interrupt signal to the sequence controller 30 to notify the sequence controller 30 that the SATA I/F 50 has received the register FIS.

When the data transfer control device has determined that the register FIS reception interrupt has not occurred, the data transfer control device sets the E_Status value (D0h) of the PIO setup FIS in the status register of the TFR 12 (step S32). When the data transfer control device has received a PIO setup FIS from the device (step S35), the data transfer control device sets the transfer direction (read or write), the transfer type (PIO), the sector transfer byte count (step S36), and returns to the step S27.

When the data transfer control device has determined that the register FIS reception interrupt has occurred, the data transfer control device finishes free-run transfer (step S33). The data transfer control device transfers the register value of the SFR 52 to the TFR 12 to set the status register of the TFR 12 at BUSY=0 and DRQ=0 (50h or 51h) (step S34).

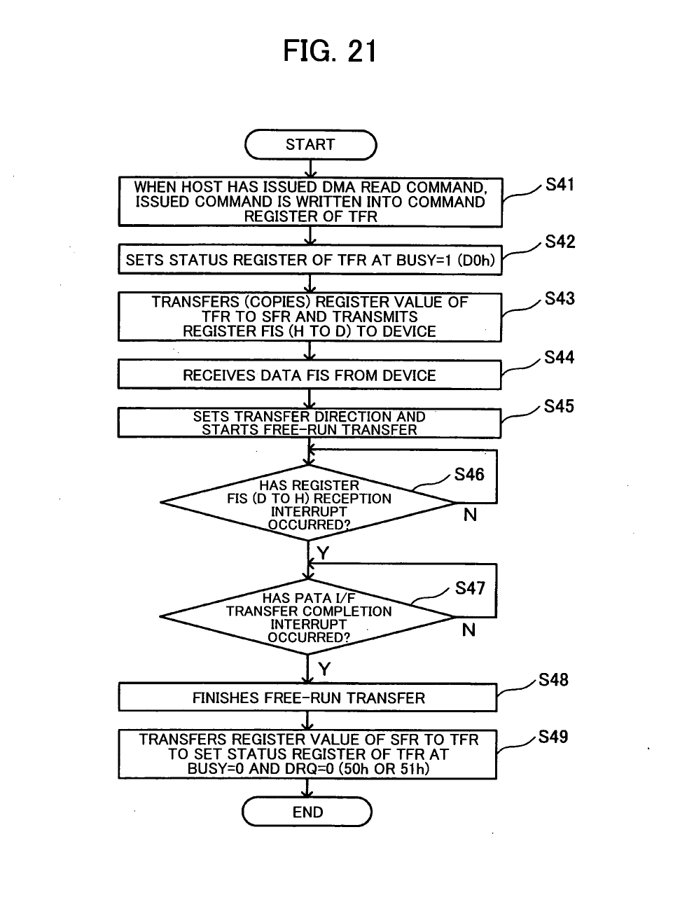

FIG. 21 is a flowchart of DMA read described with reference to FIG. 16. When the host 2 has issued a DMA read command, the issued command is written into the command register of the TFR 12 (step S41). The data transfer control device sets the status register of the TFR 12 at BUSY=1 (D0h) (step S42). The data transfer control device transfers (copies) the register value of the TFR 12 to the SFR 52, and transmits a register FIS (Host to Device) to the device 4 (step S43).

When the data transfer control device has received a data FIS from the device 4 (step S44), the data transfer control device sets the transfer direction, and starts free-run transfer in which the total data transfer count (total DMA data count) is not managed (step S45).

The data transfer control device determines whether or not a register FIS (Device to Host) reception interrupt has occurred (step S46). When the register FIS reception interrupt has occurred, the data transfer control device determines whether or not the PATA I/F 10 has issued a transfer completion interrupt (completion of output of data to the host) (step S47). Specifically, the data transfer control device checks whether or not the reception FIFO of the SATA I/F 50 and the FIFO of the data buffer 70 have become empty, and then determines whether or not the PATA I/F 10 has issued a transfer completion interrupt.

When the data transfer control device has determined that the PATA I/F 10 has issued a transfer completion interrupt, the data transfer control device finishes free-run transfer (step S48). The data transfer control device transfers the register value of the SFR 52 to the TFR 12 to set the status register of the TFR 12 at BUSY=0 and DRQ=0 (50h or 51h) (step S49).

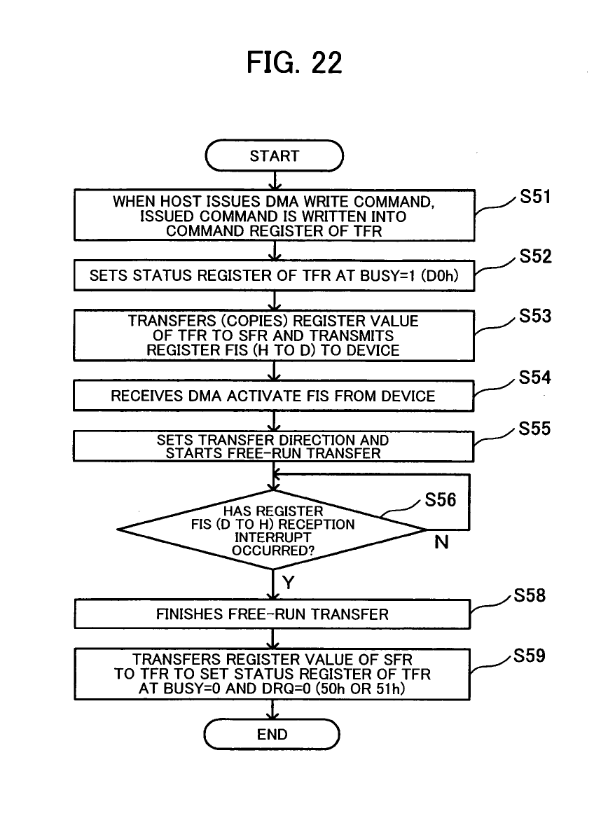

FIG. 22 is a flowchart of DMA write described with reference to FIG. 17. FIG. 22 differs from FIG. 21 in that the data transfer control device does not determine whether or not the PATA I/F has issued a transfer completion interrupt. Specifically, the data transfer control device can determine that free-run transfer may be finished during DMA write when the data transfer control device has received a register FIS from the device 4 (step S56).

In this embodiment, during the data read operation such as PIO read shown in FIG. 19 or DMA read shown in FIG. 21, the register value is set in the TFR 12 (steps S12 and S14 in FIG. 19 and step S49 in FIG. 21) after completion of data transfer from the PATA I/F 10 to the host 2 (step S10 in FIG. 19 and step S47 in FIG. 21), as described with reference to FIG. 3C. According to this configuration, the host 2 is notified of the register value of the TFR 12 after data transfer has been appropriately completed and it has been confirmed that data does not remain in the data transfer control device, whereby an appropriate read operation can be implemented.

In this embodiment, during a data write operation such as PIO write shown in FIG. 20 or DMA write shown in FIG. 22, the register value is set in the TFR 12 (step S34 in FIG. 20 and step S59 in FIG. 22) after the data transfer control device has received an FIS which indicates completion of data transfer through the SATA bus from the device 4 (step S31 in FIG. 20 and step S56 in FIG. 22), as described with reference to FIG. 4A. According to this configuration, the register value of the TFR 12 is rewritten and the host 2 is notified of the register value of the TFR 12 after the data transfer control device has confirmed that all data transfers to the device 4 have been completed and data does not remain in the data transfer control device utilizing the FIS received from the device 4, whereby an appropriate write operation can be implemented.

9. Transfer Sequence Control Corresponding to Type of Received FIS

In this embodiment, transfer sequence control is performed corresponding to the type of FIS received from the device 4, as indicated by the steps S4 and S5 in FIG. 19, the steps S24 and S25 in FIG. 20, the steps S44 and S45 in FIG. 21, and the steps S54 and S55 in FIG. 22.

Specifically, when a PIO setup FIS has been received, as indicated by the step S4 in FIG. 19 or the step S24 in FIG. 20, PIO-read or PIO-write transfer sequence control is performed. When a data FIS has been received, as indicated by the step S44 in FIG. 21, DMA-read transfer sequence control is performed. When a DMA activate FIS has been received, as indicated by the step S54 in FIG. 22, DMA-write transfer sequence control is performed. This enables appropriate transfer sequence control without decoding an ATA command from the host 2.

Specifically, a data transfer control device having a bridge function must perform transfer sequence control corresponding to an ATA command issued by the host 2. The data transfer control device must decode the ATA command in order to determine the information relating to transfer sequence control. This makes it necessary to provide a command decoder and a parameter table. Specifically, the data transfer control device decodes the command issued by the host 2, determines the transfer direction (read or write) and the transfer type (PIO or DMA), and determines the internal transfer sequence.

On the other hand, the logic circuit scale and the memory capacity of the data transfer control device must be increased when providing such a command decoder. In order to decode the ATA command, a decoding command table must be provided in the data transfer control device. However, when a new command is added to the standard after the development of the data transfer control device has been completed, it is impossible to support the new command without changing the circuit of the data transfer control device. Taking the ATAPI standard as an example, it is necessary to change a parameter table when a new-standard optical disk drive such as a blue-ray disk drive is added. This makes it impossible to use a data transfer control device which has been fully developed and makes it necessary to change its circuit in order to change a parameter table (table memory), thereby resulting in an additional development period and development cost. It is also difficult to deal with a special command specific to a vendor.

In this case, it is possible to deal with a situation in which a new command is added or the existing command is changed by incorporating a CPU (processing section) in a data transfer control device and changing a parameter table by rewriting firmware or the like.

On the other hand, when incorporating a CPU in a data transfer control device, it is necessary to develop firmware which operates on the CPU or develop a debugging tool for checking the operation of the CPU, whereby the development period and cost are increased.

In order to solve the above problems, this embodiment employs a configuration in which a command issued by the host is transferred to the device without decoding the command. A transfer sequence relating to the issued command is controlled based on information relating to an FIS returned from the device. Specifically, the SATA device decodes the ATA command instead of the data transfer control device. The data transfer control device directly transfers the ATA command to the SATA device without decoding the ATA command (the data transfer control device may partially decode the ATA command), and determines and executes its transfer sequence depending on the reaction of the SATA device.

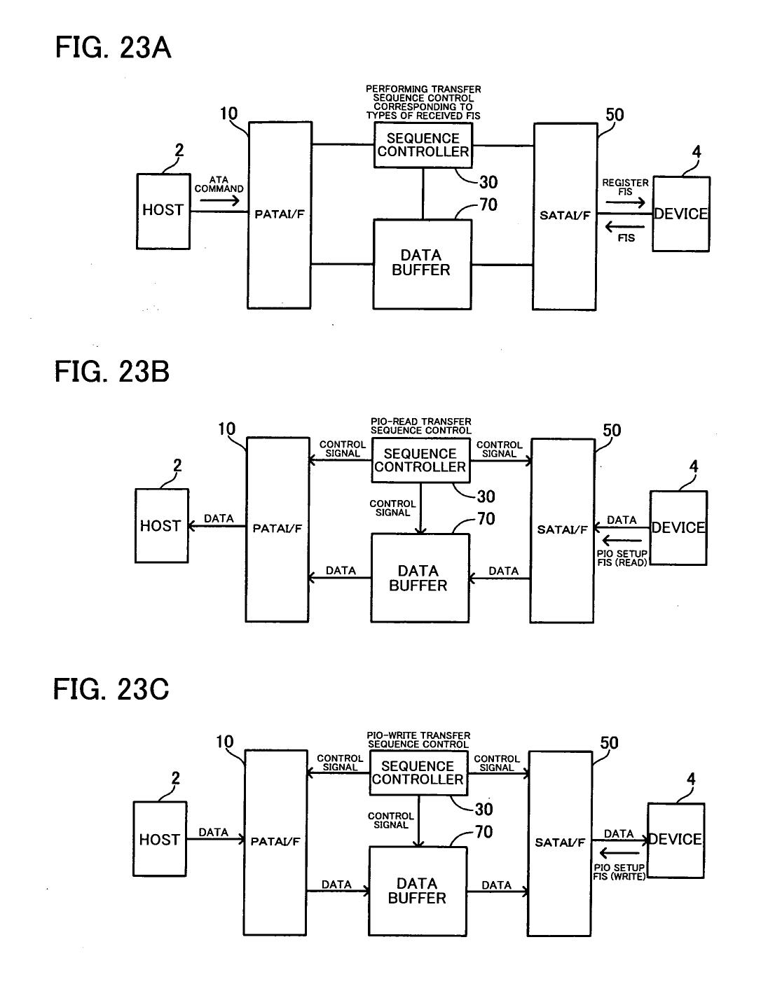

As shown in FIG. 23A, when the host 2 has issued an ATA command (transfer command) through the PATA bus, the PATA I/F 10 receives the command. The SATA I/F 50 creates a register FIS (Host to Device) including the issued ATA command, and transmits the register FIS to the device 4 through the SATA bus.

When a SATA I/F (not shown) of the device 4 has received the register FIS, the SATA I/F decodes the register FIS, and transmits an FIS corresponding to the register FIS (ATA command). The SATA I/F 50 receives the transmitted FIS.

When the SATA I/F 50 has received the FIS corresponding to the register FIS from the device 4, the sequence controller 30 (transfer sequencer or bridge sequencer) performs transfer sequence control corresponding to the type of the received FIS as transfer sequence control for the ATA command issued by the host 2.

In FIG. 23B, the host 2 has issued a PIO-read ATA command. In this case, the device 4 transmits a PIO setup FIS of which the transfer direction is the read direction. Specifically, the device 4 transmits a PIO setup FIS which is an FIS transferred from the device 4 to the host 2 immediately before PIO data transfer, and the SATA I/F 50 receives the PIO setup FIS. The PIO setup FIS includes a data transfer initial status (Status) and a data transfer end status value (E_Status).

When the received FIS is a PIO setup FIS and the transfer direction specified by the PIO setup FIS is the read direction, the sequence controller 30 performs PIO-read transfer sequence control. Specifically, the sequence controller 30 outputs PIO-read transfer sequence control signals (e.g., transfer direction setting signal, transfer start signal, and transfer stop signal) to the SATA I/F 50, the data buffer 70, and the PATA I/F 10. This causes the data read from the device 4 to be transferred to the host 2 through the SATA I/F 50, the data buffer 70, and the PATA I/F 10.

In FIG. 23C, the host 2 has issued a PIO-write ATA command. In this case, the device 4 transmits a PIO setup FIS of which the transfer direction is the write direction, and the SATA I/F 50 receives the PIO setup FIS.

When the received FIS is a PIO setup FIS and the transfer direction specified by the PIO setup FIS is the write direction, the sequence controller 30 performs PIO-write transfer sequence control. Specifically, the sequence controller 30 outputs PIO-write transfer sequence control signals to the PATA I/F 10, the data buffer 70, and the SATA I/F 50. This causes the data from the host 2 to be transferred to the device 4 through the PATA I/F 10, the data buffer 70, and the SATA I/F 50.

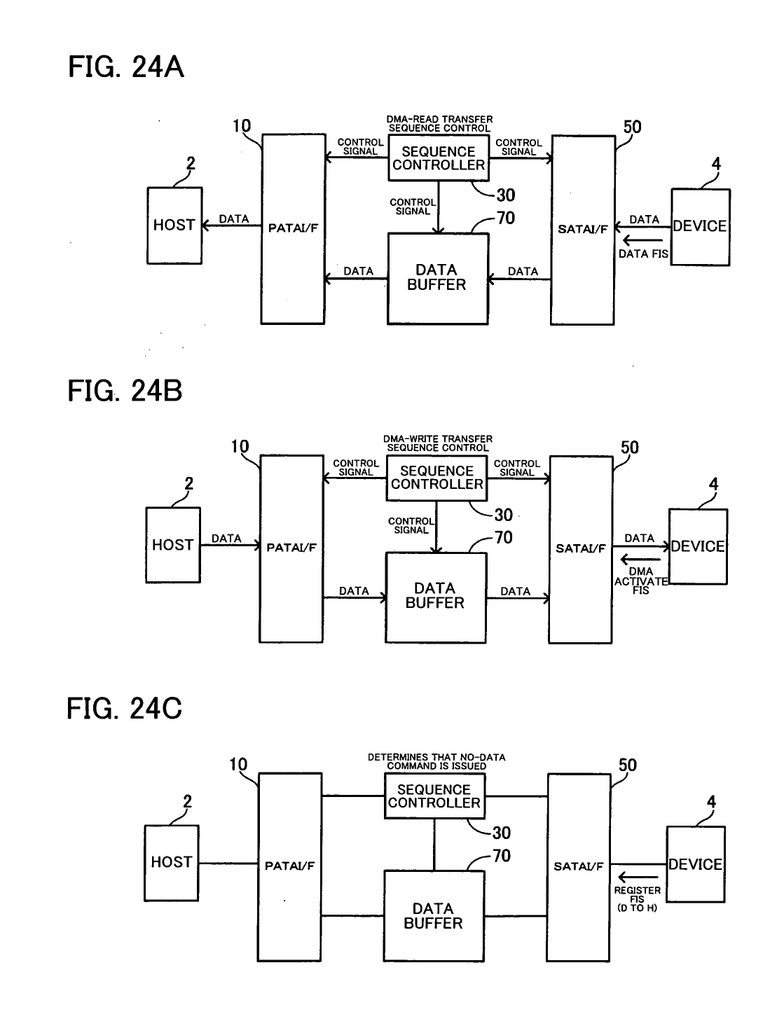

In FIG. 24A, the host 2 has issued a DMA-read ATA command. In this case, the device 4 transmits a data FIS. Specifically, the device 4 transmits a data-transfer data FIS, and the SATA I/F 50 receives the data FIS.

As described above, when the received FIS is a data FIS, the sequence controller 30 performs DMA-read transfer sequence control. This causes the data read from the device 4 to be DMA-transferred to the host 2 through the SATA I/F 50, the data buffer 70, and the PATA I/F 10.

In FIG. 24B, the host 2 has issued a DMA-write ATA command. In this case, the device 4 transmits a DMA activate FIS. Specifically, the device 4 transmits the DMA activate FIS which notifies the host 2 that the device 4 has prepared for DMA transfer, and the SATA I/F 50 receives the DMA activate FIS.

As described above, when the received FIS is a DMA activate FIS, the sequence controller 30 performs DMA-write transfer sequence control. This causes the data from the host 2 to be DMA-transferred to the device 4 through the PATA I/F 10, the data buffer 70, and the SATA I/F 50.

In FIG. 24C, the host 2 has issued a no-data command ATA command. In this case, the device 4 transmits a register FIS (Device to Host), and the SATA I/F 50 receives the register FIS. When the received FIS corresponding to the ATA command is a register FIS from the device 4 to the host 2, the sequence controller 30 determines that the ATA command issued by the host 2 is a no-data command. The sequence controller 30 transfers the register value of the register FIS from the shadow task file register of the SATA I/F 50 to the task file register of the PATA I/F 10.

As described above, the data transfer control device according to this embodiment can determine the type of the issued ATA command based on the received FIS information from the device 4 without decoding the ATA command issued by the host 2, and implement transfer sequence control corresponding to the ATA command. Therefore, the circuit of the command decoder can be reduced, whereby the size of the data transfer control device can be reduced. Moreover, even if a new command is added to the standard, it is possible to deal with such a situation without changing the circuit of the data transfer control device. Furthermore, since a CPU need not be incorporated in the data transfer control device, firmware which operates on the CPU or a debugging tool need not be developed, whereby the development period and the development cost can be reduced. Note that a modification may be made such as providing a circuit which partially decodes the ATA command or a CPU (processing section) in the data transfer control device.

In this embodiment, the transfer direction, the transfer type, and the like are set based on the parameters of the PIO setup FIS received from the device 4, as indicated by the step S5 in FIG. 19 and the step S25 in FIG. 20. Specifically, the SATA I/F 50 generates the received FIS information (transfer direction signal, transfer type signal, and FIS interrupt signal) based on the FIS decoding result, and the sequence controller 30 determines the transfer direction, the transfer type, and the like based on the received FIS information. According to this configuration, the transfer sequence can be controlled by obtaining the transfer direction, the transfer type, and the like by effectively utilizing the PIO setup FIS from the device 4 without decoding the command issued by the host 2. Therefore, appropriate transfer sequence control can be implemented while suppressing an increase in circuit scale of the sequence controller 30.

In this embodiment, when data of at least one sector has been stored in the data buffer 70 (FIFO memory), the register value of the SFR 52 is transferred to the TFR 12 to clear the BUSY bit and set the DRQ bit of the status register of the TFR 12, as indicated by the steps S6 and S7 in FIG. 19. This enables the host 2 to appropriately read data.

Specifically, since the host 2 considers the device 4 to be a PATA device, it is necessary to create a situation in which the device 4 functions as if the device 4 were a PATA device. According to this embodiment, a pseudo TFR 12 which is not defined in the SATA standard is provided, and a register value is transferred between the TFR 12 and the SFR 52.

If the BUSY bit is cleared and the DRQ bit is set before the data is sufficiently stored in the data buffer 70, the host 2 reads data from the data buffer 70 which does not store sufficient data, whereby an appropriate data read operation cannot be performed.

According to this embodiment, since the BUSY bit is cleared and the DRQ bit is set after data of at least one sector has been stored in the data buffer 70, the host 2 can perform an appropriate data read operation.

In this embodiment, the E_Status value (E_Status in FIG. 11C) of the received PIO setup FIS is set in the status register of the TFR 12 (Status in FIG. 13) after completion of data transfer between the SATA I/F 50 and the PATA I/F 10, as indicated by the steps S10 to S12 in FIG. 19 and the steps S30 to S32 in FIG. 20. Specifically, the SATA I/F 50 issues an interrupt to the sequence controller 30 (activates an interrupt signal) upon completion of output of data (FIS transfer) to the SATA bus and output of data to the data buffer 70. The PATA I/F 10 issues an interrupt to he sequence controller 30 upon completion of output of data to the PATA bus and output of data to the data buffer 70. The sequence controller 30 sets the E_Status value of the PIO setup FIS in the status register of the TFR 12 after confirming that data transfer has been completed utilizing such interrupts. Specifically, the sequence controller 30 transfers (writes) the E_Status value stored in the temporary register of the SATA I/F 50 to the TFR 12. According to this configuration, the DRQ bit of the status register is cleared after the sequence controller 30 has confirmed that all data transfers have been completed and data does not remain in the data transfer control device. This prevents a situation in which the data read operation or the data write operation of the host 2 stops before completion of data transfer, whereby data remains in the data transfer control device, for example.

10. Free-Run Transfer

In this embodiment, free-run transfer in which the total data transfer count is not managed is performed as transfer sequence control corresponding to the type of the received FIS, as indicated by the step S5 in FIG. 19, the step S25 in FIG. 20, the step S45 in FIG. 21, and the step S55 in FIG. 22. Specifically, the sequence controller 30 activates the transfer start signal (Tran Go), and then starts free-run transfer in which the total data transfer count is not counted. The sequence controller 30 activates the transfer stop signal (Tran Stop) when finishing free-run transfer. Since a circuit which counts the total data transfer count is unnecessary by performing such a free-run transfer, the circuit scale of the data transfer control device can be reduced. Moreover, since operation control (e.g., pointer control) of such a count circuit is unnecessary, the circuit and the process of the data transfer control device can be simplified.

In this embodiment, the data transfer control device finishes free-run transfer when the data transfer control device has determined that an FIS received by the SATA I/F 50 from the device 4 after starting free-run transfer is an FIS which indicates completion of all data transfers.

Specifically, the data transfer control device finishes PIO-read free-run transfer when receiving a PIO setup FIS in which the E_Status value is set at BUSY=0 and DRQ=0 after starting free-run transfer, as indicated by the step S1 in FIG. 19.

The data transfer control device finishes PIO-write free-run transfer when receiving a register FIS from the device 4 after starting free-run transfer, as indicated by the step S31 in FIG. 20. The data transfer control device finishes DMA-read free-run transfer when receiving a register FIS from the device 4 after starting free-run transfer, as indicated by the step S46 in FIG. 21. The data transfer control device finishes DMA-write free-run transfer when receiving a register FIS from the device 4 after starting free-run transfer, as indicated by the step S56 in FIG. 22. This makes it possible to finish free-run transfer without counting the total data transfer count, whereby the circuit scale can be reduced and the process can be simplified.

Note that the data transfer control device finishes DMA-read free-run transfer when data transfer from the PATA I/F 10 to the host 2 has been completed after receiving a register FIS, as indicated by the step S47 in FIG. 21. This prevents a situation in which free-run transfer data remains in the data transfer control device.

In this embodiment, when the data transfer control device has started PIO-read or PIO-write free-run transfer, a Status value in which the BUSY bit is cleared to 0 and the DRQ bit is set at 1 is transferred from the SFR 52 to the TFR 12, as indicated by the step S7 in FIG. 19 and the step S27 in FIG. 20. This allows the host 2 to be notified that preparations for data transfer have been completed (i.e., the busy state has been cancelled and the data request has been set). Therefore, the host 2 can start the data read operation or the data write operation.

When the data transfer control device performs PIO-read free-run transfer, a Status value in which the BUSY bit is cleared to 0 and the DRQ bit is set at 1 is transferred from the SFR 52 to the TFR 12 after data of at least one sector has been stored in the data buffer 70, as indicated by the steps S6 and S7 in FIG. 19. This enables the host 2 to appropriately read data.

In this embodiment, the BUSY bit and the DRQ bit of the status register of the TFR 12 are cleared to 0 when the data transfer control device has determined that free-run transfer has been completed, as indicated by the step S14 in FIG. 19 and the step S34 in FIG. 20. For example, the data transfer control device sets the E_Status value (BUSY=0 and DRQ=0) of the PIO setup FIS in the status register of the TFR 12 upon completion of PIO-read free-run transfer. Specifically, the data transfer control device transfers (writes) the E_Status value stored in the temporary register of the SATA I/F 50 to the TFR 12. The data transfer control device can notify the host 2 that all data transfers have been completed using the TFR 12 pseudo-provided for a bridge by clearing the BUSY bit and the DRQ bit to 0.

11. Register Value Transfer Using Trigger Signal

In this embodiment, a register value is transferred between the TFR 12 and the SFR 52 using the following method.

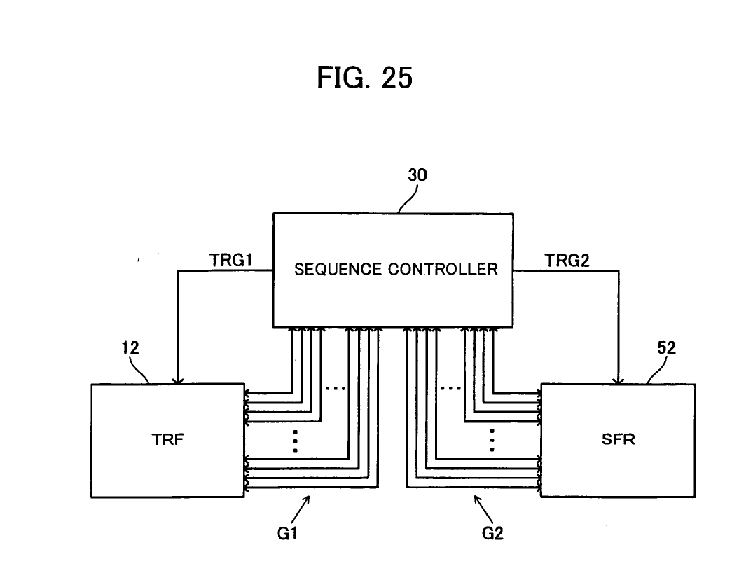

As indicated by G1 and G2 in FIG. 25, each bit (all bits) of the register group of the TFR 12 and each bit (all bits) of the register group the SFR 52 are connected through the sequence controller 30 (signal lines), for example. Specifically, signals (signal lines) output from the register group of the TFR 12 such as the control block register and the command block register (status register and command register) described with reference to FIG. 13 are input to the sequence controller 30. These signals are output to the SFR 52 through the sequence controller 30. Signals (signal lines) output from the register group of the SFR 52 such as the control block register and the command block register are also input to the sequence controller 30, and output to the TFR 12 from the sequence controller 30.

The sequence controller 30 generates register value transfer trigger signals (rewrite trigger signals) TRG1 and TRG2, and transfers a register value between the TFR 12 and the SFR 52 based on the generated transfer trigger signals TRG1 and TRG2. For example, when rewriting the register value of the TFR 12, the sequence controller 30 activates the trigger signal TRG1 to write the register value of the SFR 52 (or temporary register) into the TFR 12. When rewriting the register value of the SFR 52, the sequence controller 30 activates the trigger signal TRG2 to write the register value of the TFR 12 into the SFR 52. The trigger signals TRG1 and TRG2 may be generated based on the command write detection signal and the like described with reference to FIG. 4C.

According to the configuration shown in FIG. 25, since the register value can be transferred by simple control of merely activating the trigger signals TRG1 and TRG2, the circuit scale can be reduced and the process can be simplified. Moreover, since the sequence controller 30 can monitor the register value transferred, more intelligent register value transfer control can be realized.

12. Interrupt Signal

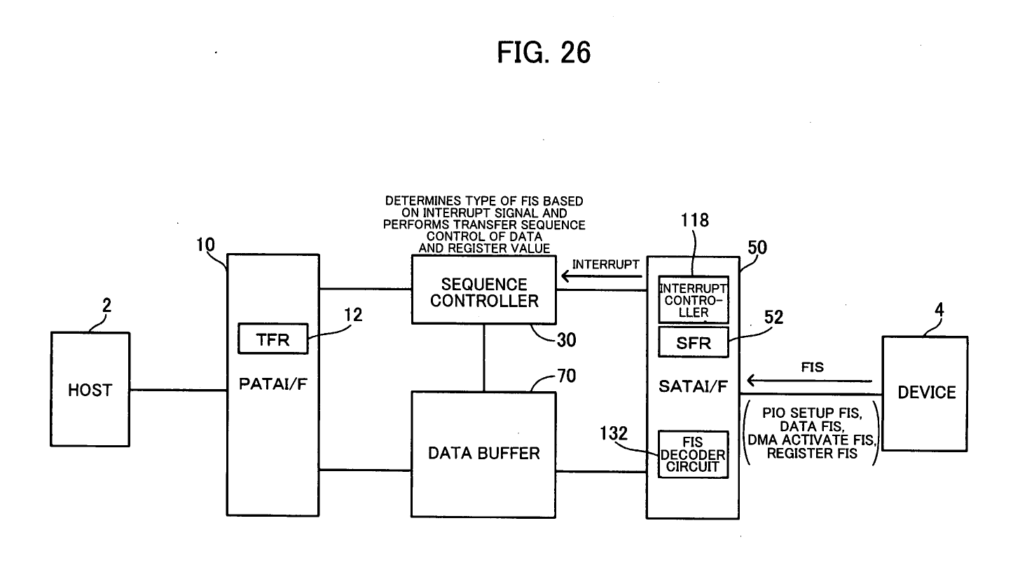

In this embodiment, the SATA I/F 50 decodes (analyzes) an FIS received from the device 4, as shown in FIG. 26. Specifically, the FIS decoder circuit 132 (see FIG. 10) included in the SATA I/F 50 decodes an FIS. The interrupt controller 118 included in the SATA I/F 50 generates and outputs an interrupt signal which notifies the sequence controller 30 of the type of the FIS based on the decoding result. Specifically, the interrupt controller 118 outputs an interrupt signal which indicates reception of a PIO setup FIS, a data FIS, a DMA activate FIS, a register FIS, or the like.

The sequence controller 30 determines the type of the FIS based on the interrupt signal from the SATA I/F 50, and controls a data/register value transfer sequence.

For example, when the sequence controller 30 has received an interrupt signal which indicates a PIO setup FIS from the SATA I/F 50, the sequence controller 30 performs PIO-read transfer sequence control shown in FIG. 23B when the transfer direction of the PIO setup FIS is the read direction, and performs PIO-write transfer sequence control shown in FIG. 23C when the transfer direction of the PIO setup FIS is the write direction. The sequence controller 30 performs DMA-read transfer sequence control shown in FIG. 24A when the sequence controller 30 has received an interrupt signal which indicates a data FIS, and performs DMA-write transfer sequence control shown in FIG. 24B when the sequence controller 30 has received an interrupt signal which indicates a DMA activate FIS.

In this embodiment, the sequence controller 30 determines the type of the FIS based on the interrupt signal from the SATA I/F 50, and controls a register value transfer sequence, as indicated by FIG. 4A, the steps S11 to S14 in FIG. 19, the steps S31 to S34 in FIG. 20, the steps S46 to S49 in FIG. 21, and the steps S56 to S59 in FIG. 22.

This enables the sequence controller 30 to determine the type of FIS by effective utilizing the FIS decoder circuit 132 which is originally required for the SATA I/F 50. This makes it unnecessary to provide an FIS decoder circuit in the sequence controller 30, whereby the circuit scale can be reduced. In this embodiment, since a decoder circuit which decodes a command issued by the host 2 also need not be provided in the sequence controller 30, the size of the data transfer control device can be further reduced. Note that the SATA I/F 50 may output a transfer direction signal which indicates the transfer direction to the sequence controller 30 in addition to the FIS interrupt signal. This enables the sequence controller 30 to determine whether the transfer direction is PIO read or PIO write by merely monitoring the transfer direction signal, whereby the circuit can be simplified.

13. Soft Reset Process

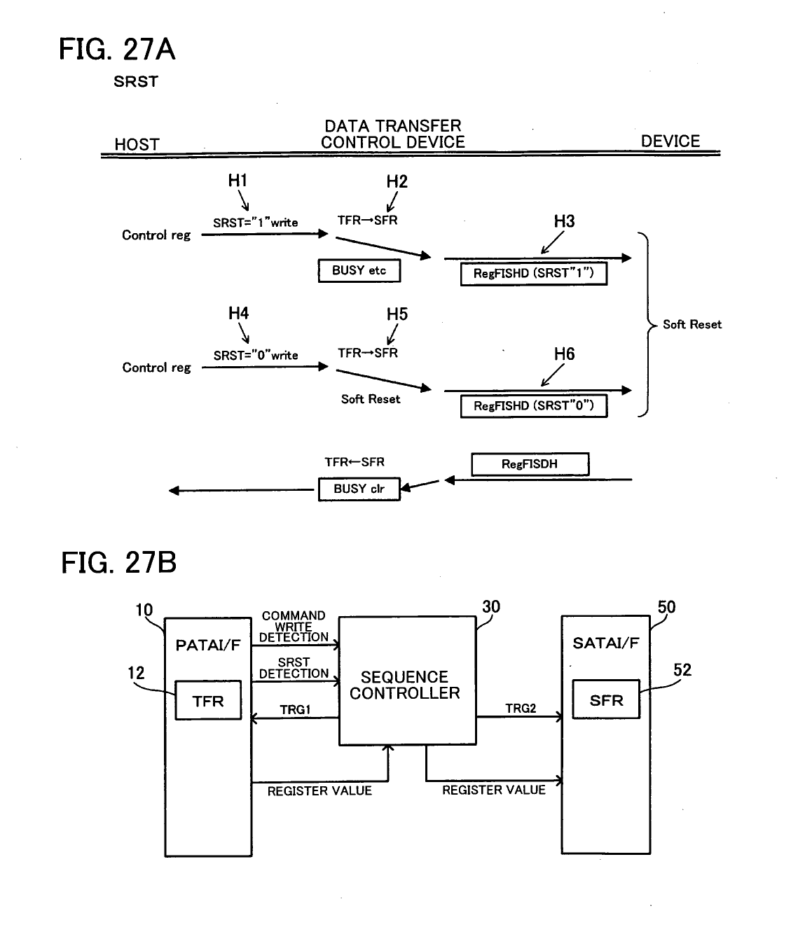

A soft reset (software reset) process is described below. When the host 2 initializes the device 4 by means of a soft reset (hereinafter appropriately referred to as “SRST”), the host 2 sets 1 in an SRST bit of the TFR 12, as indicated by H1 in FIG. 27A. Specifically, the host 2 sets 1 in the SRST bit of the device control register (Device Control) of the TFR 12 shown in FIG. 13.

When the SRST bit is set at 1, the sequence controller 30 transfers a register value in which the SRST bit is set at 1 from the TFR 12 to the SFR 52, as indicated by H2 in FIG. 27A.

As indicated by H3, the SATA I/F 50 transmits a register FIS (Host to Device) in which the SRST bit is set at 1 to the device 4. Specifically, the SATA I/F 50 sets 1 in the SRST bit of the command register of the register FIS shown in FIG. 11A, and transmits the register FIS to the device 4. When the device 4 has received the register FIS in which the SRST bit is set at 1, the device 4 prepares for a soft reset initialization sequence process.

The host 2 then clears the SRST bit of the TFR 12 to toggle the SRST bit from 1 to 0, as indicated by H4. When the SRST bit has been cleared to 0, the sequence controller 30 transfers a register value in which the SRST bit is cleared to 0 from the TFR 12 to the SFR 52, as indicated by H5. The sequence controller 30 also starts an initialization sequence process of the data transfer control device.

When the register value has been transferred from the TFR 12 to the SFR 52, the SATA I/F 50 transmits a register FIS (Host to Device) in which the SRST bit is cleared to 0 to the device 4, as indicated by H6. When the device 4 has received the register FIS in which the SRST bit is cleared to 0, the device 4 starts the soft reset initialization sequence process. The initialization sequence processes of the data transfer control device and the device 4 are performed in this manner, whereby the soft reset is implemented.

The data transfer control device must receive such a soft reset request from such host 2 irrespective of the state of the data transfer control device. In this embodiment, the PATA I/F 10 outputs an SRST detection signal (soft reset detection signal) to the sequence controller 30, as shown in FIG. 27B. Specifically, when an SRST bit rewrite event by the host 2 has occurred, the SRST detection signal becomes active. The sequence controller 30 transfers a register value based on the SRST detection signal from the PATA I/F 10. Specifically, when the SRST bit has been set at 1 or cleared to 0 so that the SRST detection signal has become active, the sequence controller 30 transfers the register value of the TFR 12 to the SFR 52. This enables the SATA I/F 50 to transmit a register FIS in which the SRST bit is set at 1 or 0.

In this embodiment, when an ATA command has been written into the TFR 12 after a parameter has been written so that the command write detection signal has become active, the sequence controller 30 transfers a register value from the TFR 12 to the SFR 52, as described with reference to FIG. 4C.

On the other hand, when the host 2 has issued a soft reset request, as described above, the data transfer control device must immediately accept the request. Since the SRST bit is not a bit of the command register, whether or not the SRST bit has been rewritten cannot be detected based on the command write detection signal. In FIG. 27B, an SRST detection signal is provided in addition to the command write detection signal, and is activated when the SRST bit has been rewritten. This makes it possible to immediately notify the device 4 that the SRST bit has been rewritten by the host 2, as indicated by H3 and H6 in FIG. 27A, whereby an appropriate soft reset process can be implemented.

14. Electronic Instrument

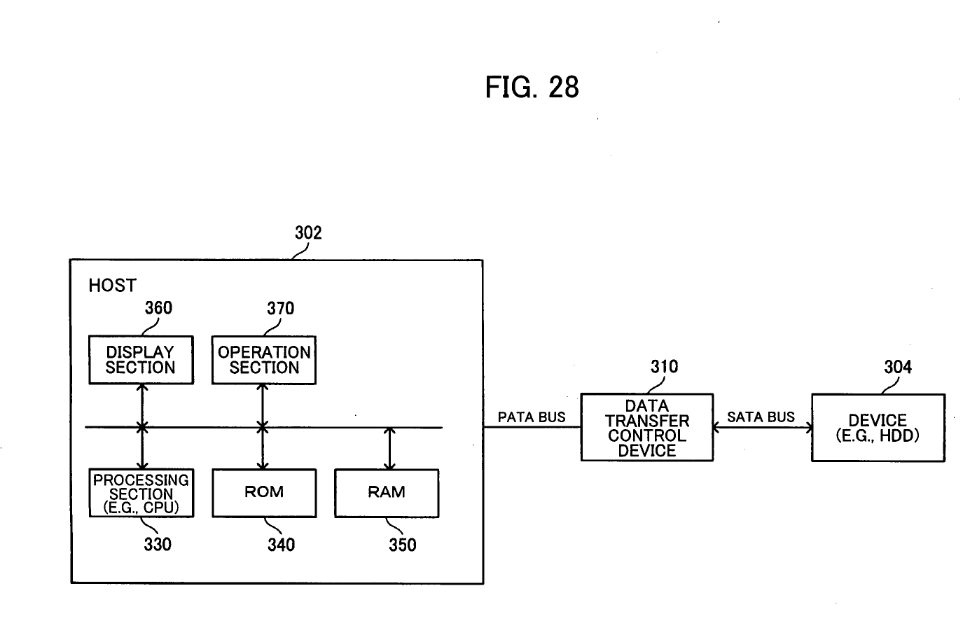

FIG. 28 shows a configuration example of an electronic instrument according to one embodiment of the invention. The electronic instrument includes a data transfer control device 310, a host 302, and a device 304 described in the above embodiment. The host 302 and the data transfer control device 310 are connected through a PATA bus, and the data transfer control device 310 and the device 304 are connected through a SATA bus. The configuration of the electronic instrument according to this embodiment is not limited to the configuration shown in FIG. 28. Various modification may be made such as omitting some elements or adding other elements.

In FIG. 28, the device 304 is a storage device such as a hard disk drive (HDD). Note that the device 304 is not limited to a storage device such as an HDD. For example, the device 304 may be an optical disk (CD or DVD) drive or the like.

The host 302 may include a processing section 330 (CPU), a ROM 340, a RAM 350, a display section 360, and an operation section 370. The processing section 330 (CPU) controls the data transfer control device 310 and the entire electronic instrument. A processing section which controls the data transfer control device 310 and a processing section which controls the electronic instrument may be provided separately. The ROM 340 stores a control program and various types of data. The RAM 350 functions as a work area and a data storage area for the processing section 330 and the data transfer control device 310. The display section 360 displays various types of information to the user. The operation section 370 allows the user to operate the electronic instrument.

According to the electronic instrument according to this embodiment, even if the host 302 does not include a SATA I/F, the SATA device 304 can be connected to the host 302 through the data transfer control device 310 and operated as if the SATA device 304 were a PATA device.

As examples of the electronic instrument to which this embodiment may be applied, a car navigation system, a car audio instrument, an HDD recorder, a video camera, a portable music player, a portable image player, a game device, a portable game device, and the like can be given.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., SATA, CPU, and interrupt signal) cited with a different term (e.g., serial bus, processing section, and received FIS information) having a broader meaning or the same meaning at least once in the specification and the drawings can be replaced by the different term in any place in the specification and the drawings. The configurations and the operations of the data transfer control device and the electronic instrument are not limited to those described in the above embodiments. Various modifications and variations may be made.

For example, the data transfer control device having the configuration shown in FIG. 1 may employ a transfer sequence control method by decoding an ATA command instead of the transfer sequence control method based on the type of the received FIS described with reference to FIGS. 23A to 24C. A modification may also be made in which the total data transfer count is counted instead of employing the free-run transfer method described with reference to FIGS. 19 to 22.

The above embodiments have been described taking an example of applying the invention to the SATA standard. Note that the invention may also be applied to a standard based on the same idea as the SATA standard or a standard developed from the SATA (SATA I, SATA II, and SAS) standard.

What is claimed is:

1. A data transfer control device that has a Parallel ATA/Serial ATA bus bridge function, the data transfer control device comprising:
a Parallel ATA interface that is connected to a Parallel ATA bus and provides an interface with a host;
a Serial ATA interface that is connected to a Serial ATA bus and provides an interface with a Serial ATA device; and
a sequence controller that controls a transfer sequence,
the Parallel ATA interface including a task file register that is a pseudo register provided to implement a Parallel ATA/Serial ATA bus bridge; and
the Serial ATA interface including a shadow task file register, a register value being transferred between the task file register and the shadow task file register.

2. The data transfer control device as defined in claim 1, the data transfer control device further comprising:
a data buffer that buffers data transferred between the host and the Serial ATA device,
data being transferred between the host and the Serial ATA device through the data buffer; and
the register value being transferred between the task file register and the shadow task file register through the sequence controller.

3. The data transfer control device as defined in claim 2, the sequence controller outputting a transfer start signal, a transfer stop signal, and a transfer direction setting signal to the Parallel ATA interface and the Serial ATA interface to control a transfer sequence of data transferred between the host and the Serial ATA device through the data buffer.

4. The data transfer control device as defined in claim 1, when the host reads data from the Serial ATA device, the sequence controller setting the register value in the task file register after data transfer from the Parallel ATA interface to the host has been completed.

5. The data transfer control device as defined in claim 1, when the host writes data into the Serial ATA device, the sequence controller setting the register value in the task file register after the sequence controller has received an FIS from the Serial ATA device, the FIS indicating completion of data transfer through the Serial ATA bus.

6. The data transfer control device as defined in claim 1, the sequence controller transferring the register value from the task file register to the shadow task file register on condition that a parameter has been written into the task file register and then an ATA command has been written into the task file register.

7. The data transfer control device as defined in claim 6,
the Parallel ATA interface activating a command write detection signal when the ATA command has been written into the task file register; and
the sequence controller transferring the register value from the task file register to the shadow task file register when the command write detection signal has been activated.

8. The data transfer control device as defined in claim 1,
each bit of a register group of the task file register and corresponding bit of a register group of the shadow task file register being connected through the sequence controller; and
the sequence controller generating a transfer trigger signal of the register value, and transferring the register value between the task file register and the shadow task file register based on the generated transfer trigger signal.

9. The data transfer control device as defined in claim 1,
the Serial ATA interface decoding an FIS received from the Serial ATA device, and generating and outputting an interrupt signal that notifies the sequence controller of the type of the FIS based on the decoding result; and
the sequence controller determining the type of the FIS based on the interrupt signal from the Serial ATA interface, and controlling a transfer sequence of data and the register value.

10. The data transfer control device as defined in claim 1,
when a soft reset bit of the task file register has been set at 1, the sequence controller transferring the register value from the task file register to the shadow task file register, the soft reset bit of the register value being set at 1;
the Serial ATA interface transmitting a register FIS to the Serial ATA device, the soft reset bit of the register FIS being set at 1;
when the soft reset bit has been cleared to 0, the sequence controller transferring the register value from the task file register to the shadow task file register, the soft reset bit of the register value being cleared to 0, and starting a soft reset initialization sequence process of the data transfer control device; and
the Serial ATA interface causing the Serial ATA device to perform a soft reset initialization sequence process by transmitting a register FIS to the Serial ATA device, the soft reset bit of the register FIS being cleared to 0.

11. The data transfer control device as defined in claim 10,
the Parallel ATA interface outputting a soft reset detection signal to the sequence controller; and
the sequence controller transferring the register value based on the soft reset detection signal output from the Parallel ATA interface.

12. An electronic instrument comprising:
the data transfer control device as defined in claim 1;
a host that is connected to the data transfer control device; and
a Serial ATA device that is connected to the data transfer control device.

13. An electronic instrument comprising:
the data transfer control device as defined in claim 2;
a host that is connected to the data transfer control device; and
a Serial ATA device that is connected to the data transfer control device.

14. An electronic instrument comprising:
the data transfer control device as defined in claim 6;
a host that is connected to the data transfer control device; and
a Serial ATA device that is connected to the data transfer control device.

15. An electronic instrument comprising:
the data transfer control device as defined in claim 10;
a host that is connected to the data transfer control device; and
a Serial ATA device that is connected to the data transfer control device.
